(19) United States
(12) Patent Application Publication
(10) Pub. No.: US 2023/0267261 A1
(43) Pub. Date: Aug. 24, 2023

(54) DESIGN SYSTEM, DESIGN METHOD AND METHOD OF MANUFACTURE OF SEMICONDUCTOR DEVICE

(71) Applicant: SAMSUNG ELECTRONICS CO., LTD., SUWON-SI (KR)

(72) Inventor: JONGHYEOK KIM, INCHEON (KR)

(21) Appl. No.: 17/895,246

(22) Filed: Aug. 25, 2022

(30) Foreign Application Priority Data
Feb. 21, 2022 (KR) 10-2022-0022060

(51) Int. Cl. G06F 30/392; G06F 30/327

(52) U.S. Cl. CPC G06F 30/392; G06F 30/327

(57) ABSTRACT

A method of designing a layout of a semiconductor device includes; receiving input data defining the semiconductor device, obtaining a first layout of the semiconductor device by performing a placement and routing in response to the input data, wherein the first layout includes a plurality of blocks, a plurality of standard cells, a plurality of decoupling capacitor cells, a plurality of filler cells, a plurality of power wirings, a plurality of ground wirings, a plurality of clock wirings, and a plurality of non-clock signal wirings, setting a target region on the first layout, wherein the target region includes a first decoupling capacitor cell among the plurality of decoupling capacitor cells, and obtaining a second layout of the semiconductor device by changing the first decoupling capacitor cell in the target region.

### CROSS-REFERENCE TO RELATED APPLICATION

This U.S. nonprovisional application claims priority under 35 USC § 119 to Korean Patent Application No. 10-2022-0022060 filed on Feb. 21, 2022 in the Korean Intellectual Property Office (KIPO), the subject matter of which is hereby incorporated by reference in its entirety.

### BACKGROUND

### 1. Technical Field

Embodiments of the inventive concept relate generally to semiconductor devices. More particularly embodiments of the inventive concept relate to methods of designing semiconductor devices, design systems for same, and methods of manufacture for semiconductor devices.

### 2. Description of the Related Art

Semiconductor devices may be manufactured by designing, forming, and connecting various elements, components, circuits and/or systems (e.g., System-on-Chip or SoC) on a substrate (e.g., a semiconductor wafer). Given their vast complexity, semiconductor devices may be designed using one or more electronic design automation (EDA) tool(s). EDA tools generally facilitate the layout, disposition and connection of elements, components, circuits and/or systems in accordance with their respective interactions and intended functionality. That is, layout designers for semiconductor device are able to more efficiently generate layouts and physical designs using EDA tools.

The design of a semiconductor device may include the layout and design of multiple physical layers, wherein each of the physical layers is populated with variably-sized elements and components as well as various connecting wiring. As the degree (or density) of integration of semiconductor devices increases, methods enabling a more robust and efficient design of semiconductor devices have been proposed.

### SUMMARY

Embodiments of the inventive concept provide methods of designing layouts for semiconductor devices that efficiently utilize available white space(s). Other embodiments of the inventive concept provide design systems capable of efficiently designing layouts for semiconductor devices, as well as methods of manufacture for semiconductor devices.

In one embodiment, the inventive concept provides a method of designing a layout of a semiconductor device. Here, the method may include; receiving input data defining the semiconductor device, obtaining a first layout of the semiconductor device by performing a placement and routing in response to the input data, wherein the first layout includes a plurality of blocks, a plurality of standard cells, a plurality of decoupling capacitor cells, a plurality of filler cells, a plurality of power wirings, a plurality of ground wirings, a plurality of clock wirings, and a plurality of non-clock signal wirings, setting a target region on the first layout, wherein the target region includes a first decoupling capacitor cell among the plurality of decoupling capacitor cells, and obtaining a second layout of the semiconductor device by changing the first decoupling capacitor cell in the target region.

In another embodiment, the inventive concept provides a design system for a semiconductor device. Here, the design system may include; a storage device configured to store information including procedures, and a processor configured to access the storage device and execute the procedures, wherein the procedures include a design module configured to receive input data defining the semiconductor device, obtain a first layout of the semiconductor device by performing a placement and routing in response to the input data, the first layout including a plurality of blocks, a plurality of standard cells, a plurality of decoupling capacitor cells, a plurality of filler cells, a plurality of power wirings, a plurality of ground wirings, a plurality of clock wirings, and a plurality of non-clock signal wirings, set a target region on the first layout, wherein the target region includes a first decoupling capacitor cell among the plurality of decoupling capacitor cells, and obtain a second layout of the semiconductor device by changing the first decoupling capacitor cell in the target region.

In still another embodiment, the inventive concept provides a method of designing a layout of a semiconductor device. Here, the method may include; receiving input data defining the semiconductor device, obtaining a first layout of the semiconductor device by performing a placement and routing in response to the input data, wherein the obtaining of the first layout includes developing a floor plan for a plurality of blocks, a plurality of standard cells, a plurality of decoupling capacitor cells and a plurality of filler cells included in the semiconductor device, developing a power plan for a plurality of power wirings and a plurality of ground wirings included in the semiconductor device, performing a placement of elements included in the plurality of blocks and the plurality of standard cells, performing a clock tree synthesis (CTS) for clock signals provided to the elements via a plurality of clock wirings included in the semiconductor device, and performing a routing of non-clock signals provided to the elements via a plurality of non-clock signal wirings included in the semiconductor device, verifying results of the placement and routing, and while verifying results of the placement and routing, setting a target region on the first layout, wherein the target region includes a first decoupling capacitor cell among the plurality of decoupling capacitor cells and the plurality of standard cells is not disposed in the target region, and while verifying results of the placement and routing, obtaining a second layout of the semiconductor device by replacing the first decoupling capacitor cell in the target region with a second decoupling capacitor cell having a structure different from that of the first decoupling capacitor cell. Here, the target region is a sub-region included in the semiconductor device proximate to at least one of a corner of the semiconductor device and an edge portion of the semiconductor device, and the replacing of the first decoupling capacitor cell with the second decoupling capacitor cell includes; removing at least one of a first power wiring and a first ground wiring from the first decoupling capacitor cell, arranging the second decoupling capacitor cell in the target region, and electrically connecting the second decoupling capacitor cell to a second power wiring and a second ground wiring external to the target region.

### BRIEF DESCRIPTION OF THE DRAWINGS

Advantages, benefits and features, as well as the making and use of the inventive concept may be better understood upon consideration of the following detailed description together with the accompanying drawings, in which:

FIG. 1 is a flowchart illustrating a method of designing a layout of a semiconductor device according to embodiments of the inventive concept;

FIG. 2 is a plan view illustrating exemplary blocks and cells included in a layout of a semiconductor integrated circuit;

FIG. 3A is a plan view illustrating exemplary wirings included in a layout of a semiconductor device;

FIG. 3B is a cross-sectional view taken along line I-I′ of FIG. 3A;

FIGS. 4 and 5 are respective block diagrams illustrating design systems for a semiconductor device according to embodiments of the inventive concept;

FIG. 6 is a flowchart illustrating in one example a method of designing a layout of a semiconductor device according embodiments of the inventive concept;

FIGS. 7A, 7B and 7C are respective, conceptual diagrams further illustrating various aspects of the method of FIG. 6;

FIG. 8 is a flowchart further illustrating in one example the setting of the target region on a first layout of FIG. 1;

FIG. 9 is a flowchart further illustrating in one example the setting of the target region on a partial region of a semiconductor device of FIG. 8;

FIG. 10 is a conceptual diagram further illustrating in one example the method of FIG. 9;

FIG. 11 is a flowchart further illustrating in another example the setting the target region on the partial region of the semiconductor device of FIG. 8;

FIGS. 12A and 12B are respective, conceptual diagrams further illustrating the method of FIG. 11;

FIG. 13 is a flowchart further illustrating in still another example the setting of the target region on the partial region of the semiconductor device of FIG. 8;

FIGS. 14A and 14B are respective, conceptual diagrams further illustrating the method of FIG. 13;

FIG. 15 is a flowchart further illustrating in one example the setting of the target region on the first layout of FIG. 1;

FIG. 16 is a flowchart further illustrating in one example the setting of the target region on the partial sub-region of the at least one block in method of FIG. 15;

FIG. 17 is a conceptual diagram further illustrating the method of FIG. 16;

FIGS. 18 and 19 are flowcharts further illustrating in various examples the setting of the target region on the partial sub-region of the at least one block in the method of FIG. 15;

FIG. 20 is a flowchart further illustrating in one example the obtaining of the second layout in the method of FIG. 1;

FIG. 21 is a flowchart illustrating in one example the replacing of the first decoupling capacitor cell with a second decoupling capacitor cell in the method of FIG. 20;

FIGS. 22A, 22B, 22C, 22D, 23A, 23B, 23C, 23D, 23E and 23F are respective diagrams further illustrating in various aspects the method of FIG. 21;

FIG. 24 is a flowchart further illustrating in another example the obtaining of the second layout in the method of FIG. 1;

FIG. 25 is a flowchart further illustrating in one example the generating of the first modified decoupling capacitor cell in the method of FIG. 24;

FIGS. 26A and 26B are respective, conceptual diagrams further illustrating the method of FIG. 25;

FIG. 27 is a flowchart illustrating a method of designing a semiconductor device according to embodiments of the inventive concept; and

FIG. 28 is a flowchart illustrating a method of manufacture for a semiconductor device according to embodiments of the inventive concept.

### DETAILED DESCRIPTION

Throughout the written description and drawings, like reference numbers and labels are used to denote like or similar elements, components, features and/or method steps. Throughout the written description certain geometric terms may be used to highlight relative relationships between elements, components and/or features with respect to certain embodiments of the inventive concept. Those skilled in the art will recognize that such geometric terms are relative in nature, arbitrary in descriptive relationship(s) and/or directed to aspect(s) of the illustrated embodiments. Geometric terms may include, for example: height/width; vertical/horizontal; top/bottom; higher/lower; closer/farther; thicker/thinner; proximate/distant; above/below; under/over; upper/lower; center/side; surrounding; overlay/underlay; etc.

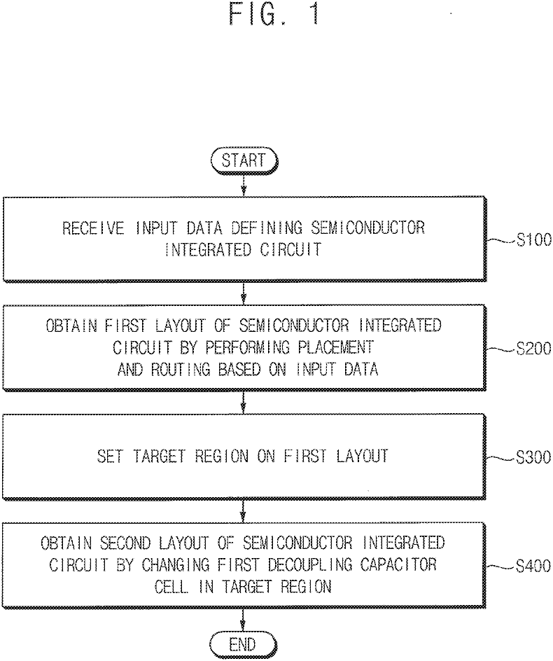

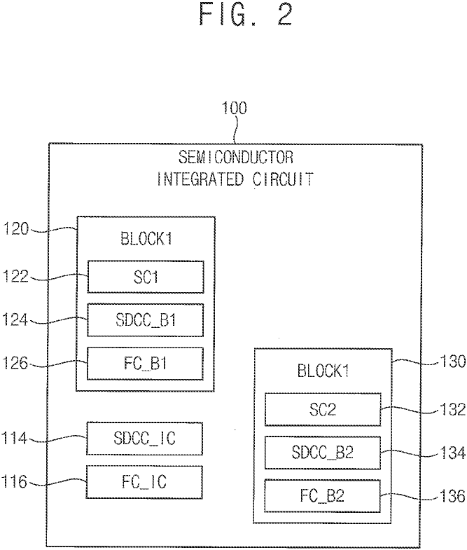

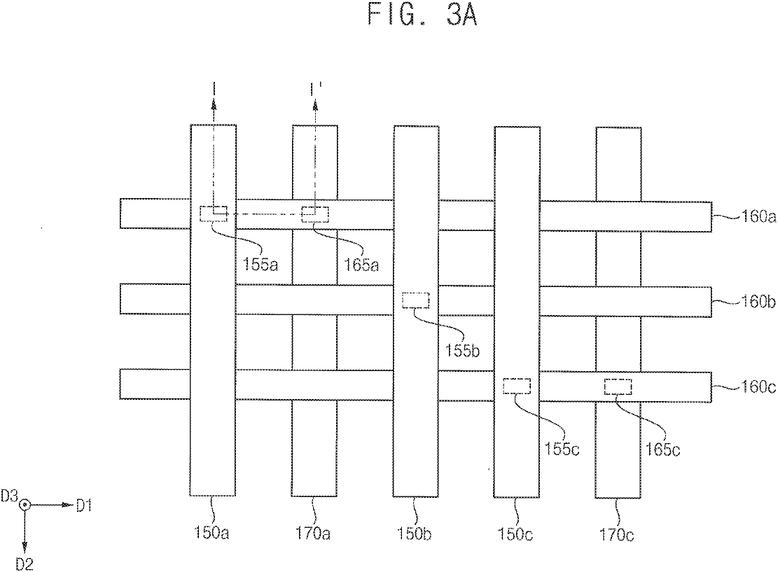

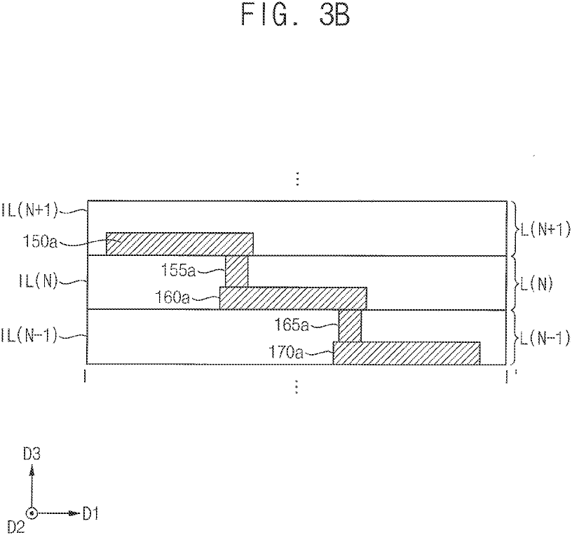

FIG. 1 is a flowchart illustrating a method of designing a layout of a semiconductor integrated circuit according to embodiments of the inventive concept. FIGS. 2, 3A and 3B are respective diagrams further illustrating a method of designing a layout of a semiconductor integrated circuit according to embodiments of the inventive concept, wherein FIG. 2 is a plan view illustrating exemplary blocks and cells included in a layout of a semiconductor integrated circuit, FIG. 3A is a plan view illustrating exemplary wirings included in a layout of a semiconductor device, and FIG. 3B is a cross-sectional view illustrating a layout of a semiconductor integrated circuit taken along line I-I′ of FIG. 3A. Hereafter, the term “semiconductor device” will be interchangeably used to generically denote one or more of a great variety of semiconductor integrated devices to which one or more embodiments of the inventive concept may be applied.

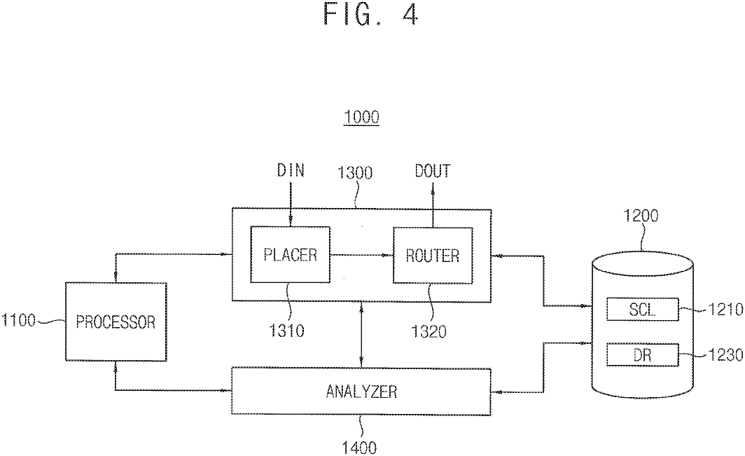

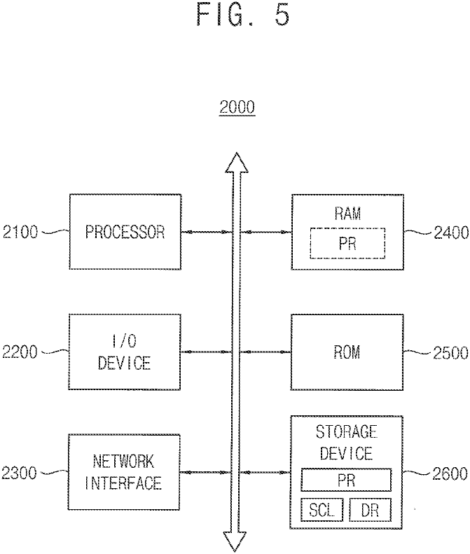

Here, the method of designing a layout of a semiconductor device may be performed during the design process of the semiconductor device, wherein at least a portion of the design method may be performed using a design system and/or a design tool. In this regard, the design system and/or design tool may include programming code defining instructions executable by one or more processor(s). Further in this regard, one example of a design system and/or design tool will be described hereafter in some additional detail with reference to FIGS. 4 and 5.

Referring to FIG. 1, in the method of designing a layout of a semiconductor device according to embodiments of the inventive concept, input data defining the semiconductor integrated circuit (e.g., a semiconductor device or a semiconductor chip) is received (S100). Here, the input data may correspond to a later obtained first layout.

In some embodiments, the input data may be data generated in an abstract or conceptual form in relation to behavioral or functional features of the semiconductor device. For example, the input data may be defined in a register transfer level (RTL) through synthesis. More particularly, the input data may be a bitstream or a netlist generated by synthesizing the semiconductor device using a hardware description language (HDL), such as VHSIC hardware description language (VHDL) or Verilog.

In some embodiments, the input data may be data defining the layout of the semiconductor device. For example, the input data may include geometric information defining a structure, as implemented by one or more semiconductor material(s), conductive material(s) (e.g., one or more metals), and insulation material(s). The layout of the semiconductor device, as indicated by the input data, may include one or more layout(s) of cells and conducting wires interconnecting the cells, for example.

Accordingly, a first layout of the semiconductor device may be obtained by performing a placement and routing (P&R) procedure based on (in response to) the input data (S200). The first layout may include a plurality of blocks, a plurality of standard cells, a plurality of decoupling capacitor cells, a plurality of filler cells, a plurality of power wirings (or wires), a plurality of ground wirings, a plurality of clock wirings, and a plurality of non-clock signal wirings. In this regard, a “non-clock signal” is any signal other than a clock signal, wherein ready examples of a non-clock signal include; a control signal, an address signal, an input signal, and an output signal.

Referring to FIG. 2, a semiconductor device 100 may include a plurality of blocks 120 and 130, wherein the plurality of blocks 120 and 130 may be referred to as functional blocks or intellectual properties (IPs). For example, the plurality of blocks 120 and 130 may include macro blocks processing and/or calculating data, and/or memory blocks storing data.

The plurality of blocks 120 and 130 may include a plurality of standard cells 122 and 132, a plurality of decoupling capacitor cells 124 and 134, and a plurality of filler cells 126 and 136. For example, the first block 120 may include the first standard cell (SC1) 122, the first decoupling capacitor cell (SDCC_B1) 124 and the first filler cell (FC_B1) 126, and the second block 130 may include the second standard cell (SC2) 132, the second decoupling capacitor cell (SDCC_B2) 134 and the second filler cell (FC_B2) 136.

In addition, the semiconductor device 110 may further include a decoupling capacitor cell (SDCC_IC) 114 and a filler cell (FC_IC) 116. That is, the decoupling capacitor cells 114, 124 and 134 and the filler cells 116, 126 and 136 may be disposed (or arranged) not only internal to the plurality of blocks 120 and 130, but also external to the plurality of blocks 120 and 130.

The standard cell may be understood as a unit of an integrated circuit in which a size of the layout meets a preset rule or criterion. The decoupling capacitor cell may represent a cell including a decoupling capacitor, and for example, may be referred to as a standard cell-type decoupling capacitor cell (or a standard decoupling capacitor cell). The filler cell may be understood as a cell filling a space between standard cells and/or decoupling capacitor cells without any specific function.

Function(s) and operation(s) of the semiconductor device 100 may be implemented by the plurality of blocks 120 and 130 and/or the plurality of standard cells 122 and 132 included in the semiconductor device 100. That is, the plurality of blocks 120 and 130 and/or the plurality of standard cells 122 and 132 may be functional circuit blocks (or logic circuit blocks) predefined to be implemented in the semiconductor device 100. In this regard, in some embodiments, a function may be parameterized. Each of the plurality of blocks 120 and 130 and/or each of the plurality of standard cells 122 and 132 may include a plurality of elements, components, circuits, devices and/or system (e.g., SoC) that collectively or individually enable various functions and operations of the semiconductor device 100. In this regard, the plurality of elements may include active elements, passive elements, analog elements, digital elements, logic elements, or the like.

The blocks 120 and 130, the standard cells 122 and 132, the decoupling capacitor cells 114, 124 and 134 and/or the filler cells 116, 126 and 136 may be formed or disposed on a semiconductor substrate.

The number of blocks, standard cells, decoupling capacitor cells and filler cells included in the semiconductor device 100 may be vary by design.

Referring to FIGS. 3A and 3B, the semiconductor device 100 may include a plurality of wiring (or wiring lines) (e.g., 150a, 150b, 150c, 160a, 160b, 160c, 170a and 170c), as well as a plurality of vias (e.g., 155a, 155b, 155c, 165a and 165c). For example, the plurality of wiring 150a to 150c, 160a to 160c, 170a and 170c may include power wirings supplying one or more power supply voltage(s) to the blocks 120 and 130, the standard cells 122 and 132 and/or the decoupling capacitor cells 114, 124 and 134, ground wirings connecting ground voltage to the blocks 120 and 130, the standard cells 122 and 132 and/or the decoupling capacitor cells 114, 124 and 134, clock wirings connecting various clock signals to the blocks 120 and 130 and/or the standard cells 122 and 132, and non-clock signal wirings providing signals, other than the clock signals, to the blocks 120 and 130 and/or the standard cells 122 and 132. In some embodiment, the plurality of wiring 150a to 150c, 160a to 160c, 170a and 170c may be formed of at least one conductive material selected from copper, tungsten, titanium, aluminum, or other conductive materials.

The first wirings 150a to 150c may be formed in a first wiring layer L(N+1), may be disposed in a first direction D1, and extend in a second direction D2 crossing (e.g., substantially perpendicular to) the first direction D1. The second wirings 160a to 160c may be formed in a second wiring layer L(N), may be disposed in the second direction D2 and may extend in the first direction D1. The third wirings 170a and 170c may be formed in a third wiring layer L(N-1), may be disposed in the first direction D1 and may extend in the second direction D2. The wiring layers L(N+1), L(N) and L(N-1) may be vertically stacked (e.g., in a third direction D3 substantially perpendicular to the first and second directions D1 and D2).

The first vias 155a to 155c may be formed in the third direction D3 at locations (or positions) at which the first wirings 150a to 150c and the second wirings 160a to 160c intersect, and may electrically connect the first wirings 150a to 150c with the second wirings 160a to 160c. The second vias 165a and 165c may be formed in the third direction D3 at locations at which the second wirings 160a and 160c and the third wirings 170a and 170c intersect, and may electrically connect the second wirings 160a and 160c with the third wirings 170a and 170c.

Therefore, as illustrated in FIG. 3B, the wirings 150a, 160a and 170a formed in different wiring layers L(N+1), L(N) and L(N-1) may be electrically connected by the vias 155a and 165a. Similarly, the wirings 150b and 160b may be electrically connected by the via 155b, and the wirings 150c, 160c and 170c may be electrically connected by the vias 155c and 165c. For example, the vias 155a to 155c, 165a and 165c may be implemented in various forms, such as single vias, bar vias, staple vias, or the like.

The wiring layers L(N+1), L(N) and L(N-1) may further include insulation layers IL(N+1), IL(N) and IL(N-1), respectively formed on the wirings 150a to 150c, 160a to 160c, 170a and 170c. For example, the wiring layers L(N+1), L(N) and L(N-1) may include a standard cell-level wiring layer that is the lowest-level layer and is connected to standard cells, a block-level wiring layer having a higher level than the standard cell-level wiring layer and connected to blocks, and a chip-level wiring layer that is the highest-level layer and is connected to the semiconductor device or chip.

The number of wiring layers and wirings included in the semiconductor device 100 may vary by design.

Referring to FIG. 1, after the first layout of the semiconductor integrated circuit has been obtained, a target region (or area) may be “set” (e.g., identified or designated) on the first layout (S300). Here, the target region may be a region including a first decoupling capacitor cell among the plurality of decoupling capacitor cells. For example, the target region may be a region in which blocks and/or standard cells are not disposed, such that only decoupling capacitors and/or filler cells may be disposed in the first layout. That is, the target region may be understood as an unused region (or a remaining region) sometimes referred to as a white space or empty space within the first layout.

In some embodiments, the target region may be set on a partial region of the semiconductor device. That is, the target region may be set by units of semiconductor device.

In some embodiments, the target region may be set on a partial sub-region of one block among the plurality of blocks included in the semiconductor device. That is, the target region may be set by units of blocks.

In some embodiments, the target region may be set on both a partial region of the semiconductor device and a partial sub-region of one block.

Referring to FIG. 1, a second layout of the semiconductor device may be obtained by changing the first decoupling capacitor cell in the target region (S400). For example, the first layout and the second layout may be logically and substantially the same, except for certain difference(s) associated with the changing of the first decoupling capacitor cell. For example, when the first decoupling capacitor cell is changed, a decoupling capacitance may be changed (e.g., increased or decreased), leakage power may be decreased, etc.

In some embodiments, the second layout may be obtained by replacing the first decoupling capacitor cell with a second decoupling capacitor cell having a different structure. That is, a selective “replacement” of the first decoupling capacitor cell may be performed. In some other embodiments, the second layout may be obtained by generating a first modified decoupling capacitor cell by adding at least one wiring, while otherwise maintaining the structure of the first decoupling capacitor cell. That is, a selective “modification” of the first decoupling capacitor cell may be performed. And it follows that in still some other embodiments, both replacement and modification of the first decoupling capacitor cell may be performed.

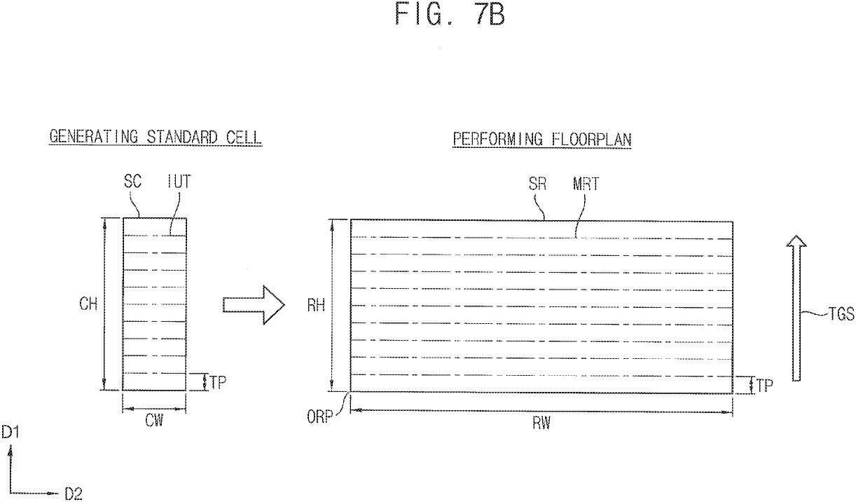

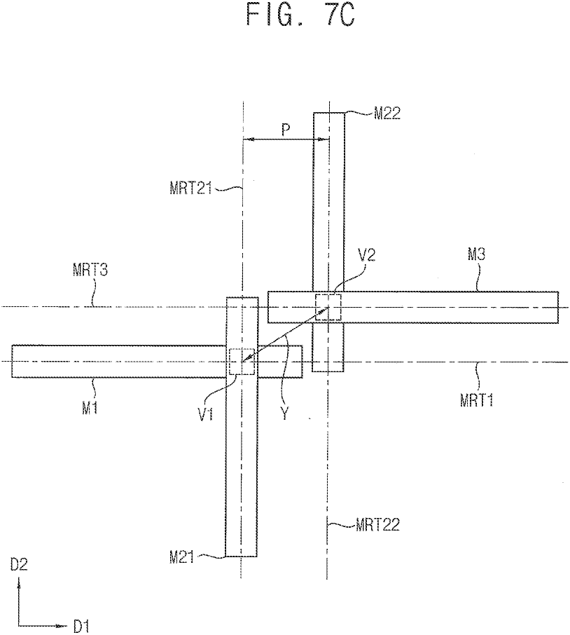

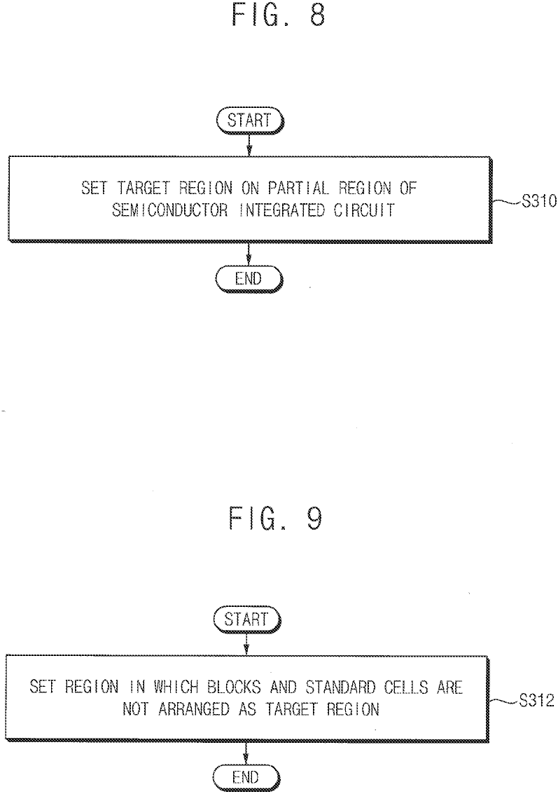

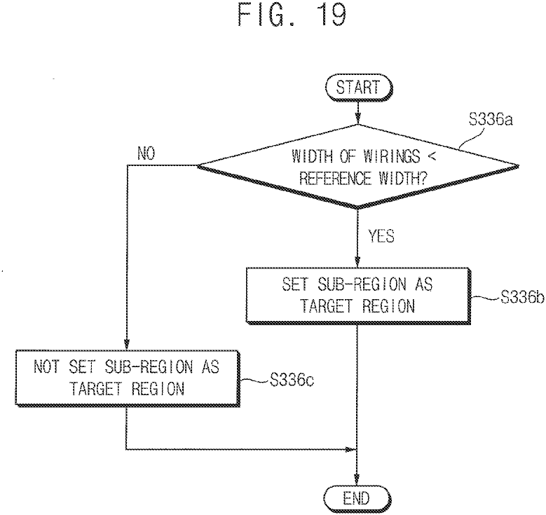

Within the illustrated method of FIG. 1, method steps S300 and S400 may be sequentially performed. Alternately, method steps S300 and S400 may be substantially simultaneously or concurrently performed (e.g., at least partially overlapping in time). Hereafter, example(s) of method step S300 will be described with reference to FIGS. 8 through 19, and example(s) of method step S400 will be described with reference to FIGS. 20 through 26.

In some embodiments, after step S400 has been performed, output data defining the semiconductor device may be generated, wherein the output data corresponds to the second layout. Here, when the received input data is a bitstream or netlist generated by synthesizing the semiconductor device, then the output data may be a bitstream or netlist. Alternately, when the received input data is defined in accordance with (e.g.,) a graphic data system II (GDSII) format, then output data may be defined in accordance with the GDSII format.

One or more of the foregoing method steps may be performed using a design tool, such as a Fusion Compiler tool by Synopsys, Inc., or an Innovus tool by Cadence Design Systems, Inc. However, these are merely ready examples of commercially available design tools.

Consistent with the foregoing, in certain methods of designing the layout of the semiconductor device according to embodiments of the inventive concept, a decoupling capacitor associated with a decoupling capacitor cell disposed in “white space” (e.g., an unused region, or a remaining region wherein standard cells are not disposed) may be changed (e.g. replaced and/or modified). This change may be performed after placement and routing has been performed in relation to the semiconductor device. Accordingly, a more robust design may be implemented by effectively utilizing the white space, and the design of the semiconductor device may be improved to enhance overall performance (e.g., by increasing the decoupling capacitance and/or reducing leakage power).

FIGS. 4 and 5 are respective block diagrams illustrating design systems that may be used to design a semiconductor device according to embodiments of the inventive concept.

Referring to FIG. 4, a design system 1000 may include; a processor 1100, a storage device 1200, a design module 1300 and an analyzer (or analysis module) 1400.

Herein, the term “module” may indicate, but is not limited to, software and/or hardware component(s), such as a field programmable gate array (FPGA) or an application specific integrated circuit (ASIC). A module may be stored in tangible addressable storage medium and may be executable by one or more processors. For example, a “module” may include components such as software components, object-oriented software components, class components and task components, and processes, functions, routines, segments of program code, drivers, firmware, microcode, circuitry, data, databases, data structures, tables, arrays, and variables. Further, a module may be divided into a plurality of modules in accordance with functionality, etc.

The processor 1100 may be used when the design module 1300 and/or the analyzer 1400 perform various computations or calculations. In some embodiments, the processor 1100 may include a microprocessor, an application processor (AP), a central processing unit (CPU), a digital signal processor (DSP), a graphic processing unit (GPU), or the like. Although FIG. 4 shows the design system 1000 including a single processor 1100, the scope of the inventive concept is not limited thereto. For example, the design system 1000 may include multiple processors. Additionally, the processor 1100 may include one or more cache memories to increase computation capacity.

The storage device 1200 may include a standard cell library (SCL) 1210 and a design rule (DR) 1230. The standard cell library 1210 and the design rule 1230 may be stored in (and selectively provided from) the storage device 1200 to the design module 1300 and/or the analyzer 1400. For example, the standard cell library 1210 may include information associated with or related to standard cells, standard cell-type decoupling capacitor cells, etc., and the design rule 1230 may be used to verify a result of the placement and routing.

In some embodiments, the storage device (or storage medium) 1200 may include non-transitory, computer-readable, storage medium of the type commonly used to provide commands and/or data to a computational system. Here, the non-transitory, computer-readable, storage medium may include a volatile memory such as a static random access memory (SRAM), a dynamic random access memory (DRAM), or the like, and a nonvolatile memory such as a flash memory, a magnetic random access memory (MRAM), a phase-change random access memory (PRAM), a resistive random access memory (RRAM), or the like. In various embodiments, the non-transitory, computer-readable, storage medium may be inserted into the computational device, may be integrated within the computational device, and/or may be coupled to the computational device through a communication link (e.g., a network, a wireless link, etc.).

The design module 1300 may include a placer 1310 and a router 1320.

The placer 1310 may place or arrange, using the processor 1100, a plurality of blocks, a plurality of standard cells, a plurality of decoupling capacitor cells, a plurality of filler cells, etc., based on input data DIN defining the semiconductor device and the standard cell library 1210. The router 1320 may perform signal routing with respect to the placement provided from the placer 1310.

The analyzer 1400 may analyze and verify results of the placement and routing. When it is determined based on results of the analysis that the signal routing has not been successfully completed, the placer 1310 may modify a previous placement and the router 1320 may perform the signal routing with respect to the resulting modified placement. When it is determined based on results of the analysis that the signal routing has been successfully completed, the router 1320 may provide output data DOUT defining the semiconductor device.

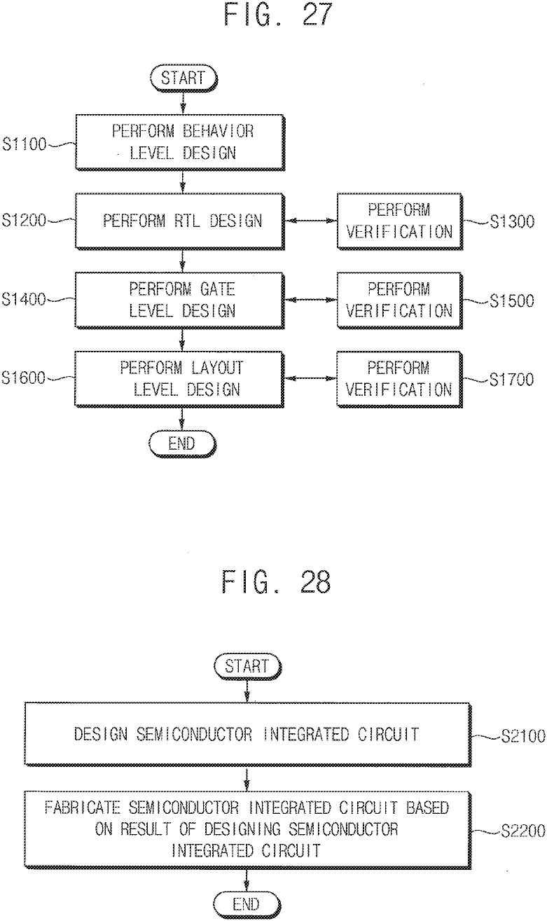

The design module 1300 may perform a method associated with designing the layout of the semiconductor device according to embodiments of the inventive concept (e.g., the method of FIG. 1). In this regard, the placer 1310 and the router 1320 included in the design module 1300 may be used to perform method steps S100, S200, S300 and S400 of FIG. 1. In addition, the design module 1300 may be used to perform other methods of designing a semiconductor device according to embodiments of the inventive concept, such as the method described hereafter with reference to FIG. 27.

In some embodiments, the placer 1310 and the router 1320 may be implemented using a single integrated module. However, in other embodiments, the placer 1310 and the router 1320 may be variously implemented using two or more modules.

The design module 1300 and/or the analyzer 1400 may be implemented in software, firmware and/or hardware. When the design module 1300 and the analyzer 1400 are primarily implemented in software, the programming code implementing the design module 1300 and the analyzer 1400 may be stored in the storage device 1200 and/or in some other storage device (not shown) separate from the storage device 1200.

Referring to FIG. 5, a design system 2000 for a semiconductor device according to embodiments of the inventive concept may include a processor 2100, an input/output (I/O) device 2200, a network interface 2300, a random access memory (RAM) 2400, a read only memory (ROM) 2500 and a storage device 2600. The illustrated example of FIG. 5 assumes that constituent module(s) (e.g., design module 1300 and analyzer 1400 of FIG. 4) used to perform design and analysis are primarily implemented in software.

In various embodiments, the design system 2000 of FIG. 5 may be implemented using a computing system. Here, the computing system may include a fixed computing system, such as a desktop computer, a workstation or a server, and/or a portable computing system, such as a laptop computer.

The processor 2100 may be substantially the same as the processor 1100 described in relation to the design system of FIG. 4. For example, the processor 2100 may include one or more processor core(s) capable of executing an arbitrary instruction set (e.g., an Intel architecture-32 (IA-32), 64 bit extension IA-32, x86-64, PowerPC, Sparc, MIPS, ARM, IA-64, etc.). The processor 2100 may access a memory (e.g., RAM 2400 and/or ROM 2500) through a bus, and may execute instructions stored in the memory. As illustrated in FIG. 5, the RAM 2400 may store at least one element of programming code PR corresponding to the design module 1300 and/or the analyzer 1400 of FIG. 4, wherein the programming code PR enables the processor 2100 to perform various operations during the verifying and/or design of a semiconductor device.

Accordingly, the programming code PR may include instructions and/or procedures executable by the processor 2100, wherein the instructions and/or procedures included in the programming code PR enable the processor 2100 to perform a method of designing a layout for a semiconductor device according to embodiments of the inventive concept. Here, the term “procedure” is used to denote a number of instructions associated with performing a certain task. Thus, a procedure may be a function, a routine, a subroutine, and/or a subprogram. Each procedure may process data provided from an external source and/or data generated internally by execution of a procedure.

The storage device 2600 may be substantially the same as the storage device 1200 described in relation to FIG. 4. Thus, the storage device 2600 may be used to store the programming code PR, a standard cell library SCL, and/or a design rule DR. One or more of elements of the programming code PR may be loaded from the storage device 2600 to the RAM 2400 before being executed by the processor 2100. The storage device 2600 may store a file written in a program language, and the programming PR generated by a compiler or the like or at least some elements of the program PR may be loaded to the RAM 2400.

The storage device 2600 may store data to-be-processed by the processor 2100, or data obtained through processing performed by the processor 2100. The processor 2100 may process the data stored in the storage device 2600 to generate new data using programming code PR. Thereafter, the new data may be stored in the storage device 2600.

The I/O device 2200 may include an input device, such as a keyboard, a pointing device, or the like, and may include an output device such as a display device, a printer, or the like. Thus, a user may initiate, through use of the I/O devices 2200, execution of the programming code PR by the processor 2100. Thereafter, the input data DIN of FIG. 4 may be input, various procedures may be performed, and the output data DOUT of FIG. 4 (e.g., an error message, etc.) may be provided.

The network interface 2300 may provide access to a network external to the design system 2000. Here, the network may include computing system(s) and communication link(s), wherein the communication links may include hard-wired links, optical links, wireless links, etc. The input data DIN may be provided to the design system 2000 through the network interface 2300, and the output data DOUT may be provided to another computing system through the network interface 2300.

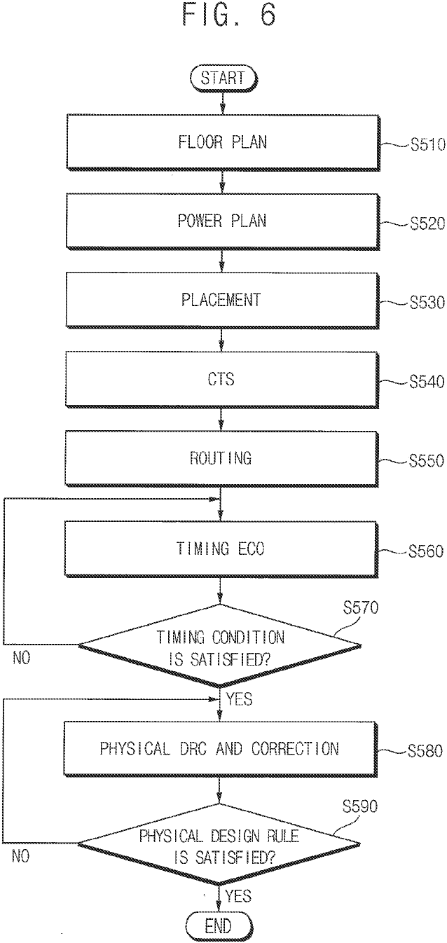

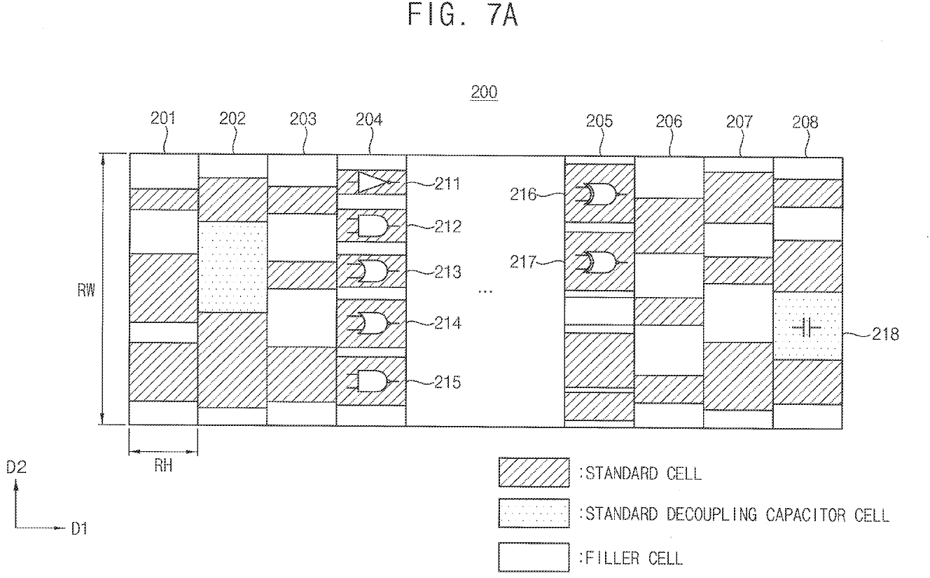

FIG. 6 is a flowchart illustrating in one example a method of designing a layout of a semiconductor device according to embodiments of the inventive concept, and FIGS. 7A, 7B and 7C are respective, conceptual diagrams further illustrating aspects of the method of FIG. 6.

Referring to FIG. 6, when designing the layout of the semiconductor device, a floor plan may be developed (S510). Here, the term “developed” is used to denote the execution (or performing) of computational procedures and/or operation. The resulting floor may define the plurality of blocks, the plurality of standard cells, the plurality of decoupling capacitor cells and/or the plurality of filler cells that are functionality associated with the semiconductor device. Here, the floor plan may include schematic placement information for gates associated with block(s) included in a semiconductor device. That is, the floor plan may define various design procedures associated with the cutting and shifting a logically designed schematic circuit(s) that are used to physically design various circuits associated with the semiconductor device. That is, the floor plan may be developed to generate a layout pattern for various memory and/or functional blocks ultimately expressed in an actual fabrication of the semiconductor device.

Once the floor plan has been developed, a power plan defining the plurality of power wirings and the plurality of ground wirings included in the semiconductor device may be developed (S520). The power plan may include schematic routing information associated with a power grid used to supply power to the gates. That is, the power plan may be used to generate a layout pattern of wirings (e.g., a wiring layout pattern) for connecting local power (e.g., a driving voltage) or a ground to variously arranged functional blocks. For example, a wiring layout pattern for connecting power and/or ground may be generated in the form of a mesh such that power is uniformly supplied across the entire chip. In this regard, various patterns may be provided in the form of a mesh based according to various design rules.

Once the power plan has been developed, a placement of elements variously included in the plurality of blocks and the plurality of standard cells may be performed (S530). Here, the placement may include determining a location (or disposition for each gate in the block. That is, the placement may be developed to generate a placement pattern for elements constituting each functional block.

A clock tree synthesis (CTS) for various clock signals selectively provided to the elements via the plurality of clock wirings may be performed (S540). The CTS may be developed to generate a layout pattern for clock signal lines associate with one or more clock circuits in view of various clock response timing used to define the overall performance of the semiconductor device.

A routing (or signal routing) of non-clock signals variously provided to elements via the plurality of non-clock signal wirings may be performed (S550). Here, routing may include operation(s) that determine routing of wires among the various gates in the block. That is, the routing may be developed to generate a layout pattern of non-clock signal lines.

Once the placement has been performed (S530), a result of the CTS (S540) and/or a result of the routing (S550) may be verified.

During verification, a timing engineering change order (ECO) process may be performed (S560). In this regard, the timing ECO process may include a static timing analysis (STA) operation, a timing update operation and/or a timing optimization operation.

After the timing ECO process has been performed, a determination of whether or not a predetermined timing condition has been satisfied may be made (S570). That is, a determination is made as to whether a timing violation (e.g., a setup timing violation, a hold timing violation, etc.) has occurred in the foregoing.

If the predetermined timing condition has not been satisfied (S570=NO), method steps S560 and S570 may be repeated. For example, to solve or improve a timing violation detected during method step S570 through the timing ECO process, cells and power wirings in the semiconductor device may be appropriately replaced and/or re-routed. In this regard, the timing ECO process may adjust a cell size, a cell location. One or more buffer(s) may be inserted, lengths and/or widths of power wirings may be adjusted, etc.

However, if the predetermined timing condition has been satisfied (S570=YES), a predetermined physical design rule check (DRC) and correction may be performed (S580). Here, the DRC may be performed in accordance with the design rule DR stored in the storage device 1200 of FIG. 4 or the storage device 2600 of FIG. 5.

Thereafter, a determination may be made as to whether the physical design rule has been satisfied (S590). If the physical design rule is not satisfied (S590=NO), then method steps S580 and S590 may be repeated. However, if the physical design rule has been satisfied (S590= YES), the design process may be deemed complete.

In some embodiments, the obtaining of the first layout of the semiconductor device by performing the placement and routing (e.g., S200 in FIG. 1) may include method steps S510, S520, S530, S540 and S550 of FIG. 6. Further, method steps S510 to S550 may be performed in accordance with received input data (e.g., the input data DIN of FIG. 4).

In some embodiments, the setting of the target region in relation to the first layout (e.g., S300 in FIG. 1) and the obtaining of the second layout of the semiconductor device by changing the first decoupling capacitor cell in the target region (e.g., S400 in FIG. 1) may be performed while verifying results of the placement and routing. For example, method steps S300 and S400 of FIG. 1 may be performed while the timing ECO process and the predetermined timing condition verification (e.g., the method steps S560 and S570) are being performed.

In some embodiments, one or more method steps described in relation to FIG. 6 may be performed for the entire semiconductor device. That is, the semiconductor device may be completely designed in one iteration of a design method according to embodiments of the inventive concept.

Alternately, one or more method steps described in relation to FIG. 6 may be performed on one or more block among the plurality of blocks included in the semiconductor device. Since many contemporary and emerging semiconductor devices are highly integrated, it may be difficult to complete the design of the entire semiconductor device in one global iteration. Accordingly, a design method according to embodiments of the inventive concept may be separately applied in more local iterations associated with one or more blocks of the semiconductor device or divided portions of the semiconductor device.. That is, in some embodiments, respective blocks of a semiconductor device may be designed using a design method according to embodiments of the inventive concept. And thereafter, the various blocks may be integrated within the semiconductor device after the design method has been performed by block(s) units.

Referring to FIG. 7A, an exemplary block 200 is assumed to be included within a semiconductor device designed in accordance with the design method of FIG. 6.

The block 200 may include a plurality of rows or site-rows 201, 202, 203, 204, 205, 206, 207 and 208 (hereafter, “rows 201 to 208”), a plurality of components represented by a plurality of standard cells 211, 212, 213, 214, 215, 216 and 217 (hereafter, “standard cells 211 to 217”), a plurality of standard decoupling capacitor cells 218, and a plurality of filler cells.

The standard cells 211 to 217 and the standard decoupling capacitor cells 218 may be generated in accordance with a stored or input standard cell library (e.g., the standard cell library SCL of FIGS. 4 and 5). The filler cells may be disposed to fill spaces between the standard cells 211 to 217 and/or the standard decoupling capacitor cells 218. In FIG. 7A, hatched rectangles indicate the standard cells, dotted rectangles indicate the standard decoupling capacitor cells, and void rectangles without any indication indicate the filler cells. Transistors of the various type for the standard cells may differ, and accordingly, the standard cells 211 to 217 may perform different functions. For example, the standard cell 211 may perform a function of an inverter; the standard cell 212 may perform an AND function; the standard cell 213 may perform an OR function; the standard cell 214 may perform a function of a NOR gate; the standard cell 215 may perform a function of a NAND gate; the standard cell 216 may perform a function of an XOR gate; and the standard cell 217 may perform a function of an XNOR gate. However, the standard cells may perform other functions associated with various logical circuits. The standard cells 211 to 217 may have various sizes according to their respective function. However, in some embodiments, all of the standard cells 211 to 217 may have the same unit height. In any case, various types of standard cells may be combined with one another to constitute a functional circuit or functional block.

Each row or site-row may serve as a frame in which the standard cells may be laid-out in the schematic of the automatically designed block 200. The plurality of rows 201 to 208 may be generated by a design system (e.g., an electronic design automation (EDA) tool). Each of the rows 201 to 208 may have a row height RH in a first direction D1 and may have a row width RW in a second direction D2. For example, the row height RH may be a unit height which is the same as that of each standard cell. The row width RW may be changed according to a function of the block 200. The rows 201 to 208 may be generated in sequence from the row 201 to the row 208 along the first direction D1. The number of rows 201 to 208 may be determined according to the function of the block 200.

The standard cells, the standard decoupling capacitor cells and the filler cells may be laid-out in the rows 201 to 208 according to a circuit configuration of the block 200. For example, the standard cells may be disposed in the rows 201 to 208 and interconnections of the standard cells may be designed. In some embodiments, the standard cells may be interconnected by metal wirings (or metal lines), wherein the metal wirings may be included in a plurality of vertically stacked layers. Metal wirings of each layer may be formed in a direction perpendicular to metal wirings of each layer adjacent thereto. For example, when metal wirings of the lowermost first layer is formed in the first direction D1, metal wirings of a second layer adjacent to the first layer may be formed in the second direction D2. Here, a unit height of the standard cell or the row may be determined in accordance with the spacing of metal wirings of the second layer formed in the second direction D2.

Referring to FIG. 7B, one example of generating a standard cell and a row is illustrated.

A design system may generate standard cells SC, may perform a floor plan based on sizes of the standard cells SC, and may design rows SR and metal routing tracks MRT for the rows SR. The metal routing tracks MRT may be virtual lines along which metal wirings of the semiconductor device may be laid-out and are to run to connect the standard cells SC in the rows SR.

In FIG. 7B, the standard cell SC having a cell height CH in the first direction D1 and a cell width CW in the second direction D2 may be generated. For example, all of the standard cells may have the same unit height as the cell height CH. However, each standard cell may have a variety of cell widths CW depending on the type.

The design system may be used to generate the standard cell SC having the unit height that is an integer multiple of the spacing of metal wirings to be formed along the metal routing tracks MRT in the second direction D2. That is, the cell height CH may be an integer multiple of the space between adjacent ones of the metal wirings. The design system may form internal unit tracks IUT in the standard cell SC at a track pitch TP corresponding to the spacing of the metal wirings. Each of the internal unit tracks IUT may be a virtual line corresponding to the metal routing tracks MRT of the row SR. Contact points of transistors of the standard cell SC may exist on the internal unit tracks IUT.

The design system may generate the row SR based on the unit height of the standard cell SC. That is, the row height RH may be the unit height. The design system may generate the metal routing tracks MRT at the track pitch TP from an origin point ORP in a direction of an arrow TGS.

The unit height of the standard cell SC may be designed as an integer multiple of the space between the metal wirings according to a standardized floor plan rule of the design system regardless of sizes of n-type metal oxide semiconductor (NMOS) transistors and/or p-type metal oxide semiconductor (PMOS) transistors of the standard cells.

Referring to FIG. 7C, an example of metal routing tracks corresponding to virtual lines for the arrangement of metal wirings is illustrated.

Metal routing tracks may be generated repeatedly in a design area of the block according to a predetermined spacing value. For example, the metal routing tracks may be generated repeatedly at regular intervals from the bottom to the top of the physical design area. In some cases, even with metal routing tracks corresponding to the same layer, an interval between metal routing tracks may be a first interval in some areas, and an interval between metal routing tracks may be a second interval different from the first interval in other areas. In addition, the metal routing tracks may generally be generated to follow a certain preferred direction.

For example, physical information associated with the metal wirings may include information of a first wiring layer, a second wiring layer and a third wiring layer formed at different levels, and may include information of a first via V1 and a second via V2 formed at different levels.

The first wiring layer may be, for example, a layer on which a metal wiring M1 is disposed, and may be formed at a first level. A first metal routing track MRT1 may be a routing track for arranging the metal wiring M1 of the first wiring layer, and may be generated along a preferred direction of the first direction D1, for example.

The second wiring layer may be, for example, a layer on which metal wirings M21 and M22 are disposed, and may be formed at a second level higher than the first level. Second metal routing tracks MRT21 and MRT22 may be routing tracks for arranging the metal wirings M21 and M22 of the second wiring layer, and may be generated along a preferred direction of the second direction D2 perpendicular to the first direction D1, for example.

The third wiring layer may be, for example, a layer on which a metal wiring M3 is disposed, and may be formed at a third level higher than the second level. A third metal routing track MRT3 may be a routing track for arranging the metal wiring M3 of the third wiring layer, and may be generated along a preferred direction of the first direction D1, for example.

Heights of the first, second and third levels may represent heights in a third direction D3 perpendicular to the first direction D1 and the second direction D2.

The first via V1 may be formed on the first wiring layer to connect the first wiring layer with the second wiring layer. For example, the first via V1 may be formed on the metal wiring M1 of the first wiring layer to provide an electrical connection with the metal wiring M21 of the second wiring layer.

The second via V2 may be formed on the second wiring layer to connect the second wiring layer with the third wiring layer. For example, the second via V2 may be formed on the metal wiring M22 of the second wiring layer to provide an electrical connection with the metal wiring M3 of the third wiring layer.

In addition, the physical information associated with the metal wirings may further include via spacing rule information Y between the first via V1 and the second via V2 and pitch information P of the second wiring layer. The via spacing rule information Y may be information representing a design rule that defines how far apart the first via V1 and the second via V2 formed at different levels should be from each other. The pitch information P may be information representing a distance between the second metal routing tracks MRT21 and MRT22 repeatedly generated at regular intervals in the second wiring layer. That is, the pitch information P may represent a distance between center lines of the metal wirings M21 and M22. The block may be designed to satisfy the via spacing rule information Y and the pitch information P.

FIG. 8 is a flowchart further illustrating in one example (S310) the setting of the target region on a first layout (S300) in FIG. 1.

Referring to FIGS. 1 and 8, when setting the target region on the first layout (S300), the target region may be set on a partial region of the semiconductor device (S310). For example, “white space” variously including unused region(s), remaining region(s), etc. in the semiconductor device may be set as the target region.

FIG. 9 is a flowchart further illustrating in one example (S312) the setting of the target region on the partial region of a semiconductor device (S310) in FIG. 8, and FIG. 10 is a conceptual diagram further illustrating the method step (S312) of FIG. 9.

Referring to FIGS. 8, 9 and 10, when setting the target region on the partial region of the semiconductor device (S310), a specific region in the semiconductor device in which the plurality of blocks and the plurality of standard cells are not arranged may be designated as the target region (S312). For example, a region proximate to a corner or edge portion of the semiconductor device, or a region proximate to a center portion of the semiconductor device may be set as the target region. That is, the target region may be designated upon consideration of various white space portions of the layout for the semiconductor device.

For example, as illustrated in FIG. 10, an I/O port PT and a plurality of blocks BLK11, BLK12, as well as BLK21, BLK22, BLK23, BLK24, BLK25, BLK26 and BLK27 (hereafter, blocks BLK21 to BLK27″) may be disposed in a semiconductor device 300. A first region REG11, proximate to an upper left corner portion of the semiconductor device layout 300, may be designated as a first white space region (i.e., a region not including blocks BLK11 to BLK12 and BLK21 to BLK27). Accordingly, a standard decoupling capacitor cell SDCC11 may be included in the first white space region REG11, as a first designated target region.

Alternately or additionally, a second region REG12, proximate to a center portion of the semiconductor device 300 may be designated as a second white space region (i.e., a region not including blocks BLK11 to BLK12 and BLK21 to BLK27). Accordingly, a standard decoupling capacitor cell SDCC12 and a filler cell FC12 may be included in the second white space region REG12, as a second designated target region.

In some embodiments, the plurality of blocks BLK11, BLK12 and BLK21 to BLK27 may include macro blocks MAC and memory blocks MEM. For example, the blocks BLK11 and BLK12 may be the macro blocks MAC, and the blocks BLK21 to BLK27 may be the memory blocks MEM. For example, the blocks BLK11 and BLK12 that are the macro blocks MAC may be arranged adjacent to the center of the semiconductor device 300, and the blocks BLK21 to BLK27 that are the memory blocks MEM may be arranged adjacent to corners and/or edges of the semiconductor device 300 (e.g., arranged to surround the blocks BLK11 and BLK12 that are the macro blocks MAC), because such arrangement is relatively advantageous in terms of the placement and routing. For example, the closer the corners and/or edges of the semiconductor device 300, the higher the possibility of being set as the target region.

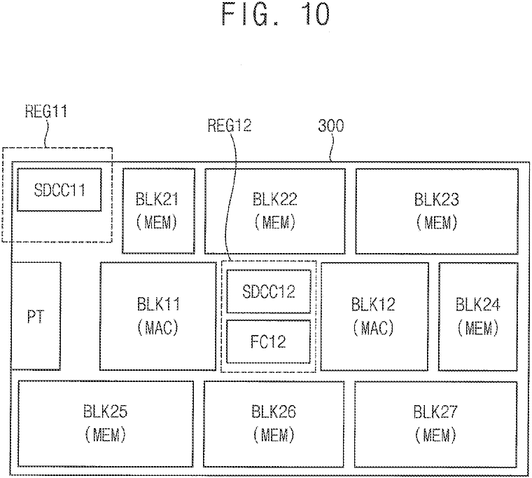

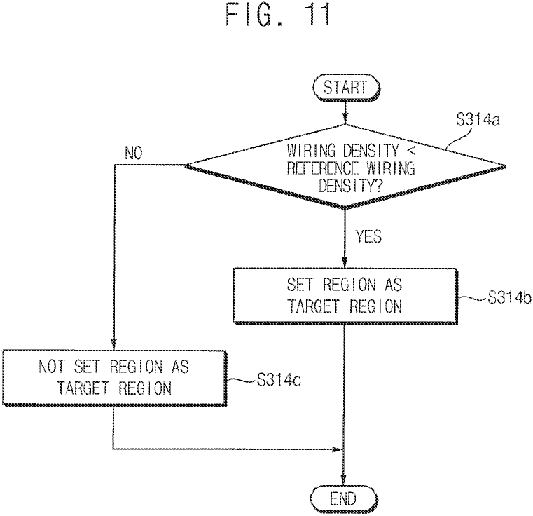

FIG. 11 is a flowchart further illustrating in another example the setting of the target region on a partial region of the semiconductor device in FIG. 8, and FIGS. 12A and 12B are respective, conceptual diagrams further illustrating the method of FIG. 11.

Referring to FIGS. 8, 11, 12A and 12B, when setting the target region on the partial region of the semiconductor device (S310), a wiring density of a specific region included in the semiconductor device may be compared with a reference wiring density (S314a). If the wiring density of the specific region is less than the reference wiring density (S314a=YES), the specific region may be set as the target region (S314b). However, if the wiring density of the specific region is not less than the reference wiring density (S314a=NO), the specific region may not be set as the target region (S314c). That is, it may be determined in relation to a wiring density threshold whether a specific region may be designated as a white space region, and therefore a target region.

In some embodiments, the wiring density of the specific region may be determined in accordance with clock wirings and non-clock signal wirings included in the specific region (e.g., based on a signal/clock network). For example, the less dense the clock wirings and the non-clock signal wirings, the higher the probability that the specific region may serve as a target region. Alternately or additionally, the wiring density of the specific region may be determined in accordance with power wirings and ground wirings included in the specific region (e.g., based on a power/ground network).

Referring to FIG. 12A, a region REG21 in the semiconductor device may include wirings M11 and M12, and may have a relatively small wiring density (e.g., may have a wiring density smaller than the reference wiring density). Thus, the region REG21 may be designated as a white space region, eligible as a target region. In contrast, referring to FIG. 12B, a region REG22 in the semiconductor device may include wirings M21, M22, M23, M24, M25, and may have a relatively great wiring density (e.g., a wiring density exceeding a reference wiring density). Thus, the region REG22 of FIG. 12B may not be deemed a white space region, and will not be designated as a target region.

In some embodiments, the wiring density may be determined or calculated in accordance with a number of wirings included in the specific region. For example, the number of the wirings M11 and M12 included in the region REG21 of FIG. 12A is less than a reference number, whereas a number of wirings M21 to M25 included in region REG22 of FIG. 12B is greater than or equal to the reference number.

In other embodiments, the wiring density may be determined or calculated in accordance with a distance (or interval) between adjacent wirings included in the specific region. For example, a first distance d11 between the wiring M11 and M12 included in the region REG21 of FIG. 12A may be greater than a reference distance, whereas a second distance d12 between the wirings M22 and M23 included in the region REG22 of FIG. 12B may be less than or equal to the reference distance.

In still other embodiments, the wiring density may be determined or calculated in accordance with a ratio of an area occupied by the wirings included in the specific region.

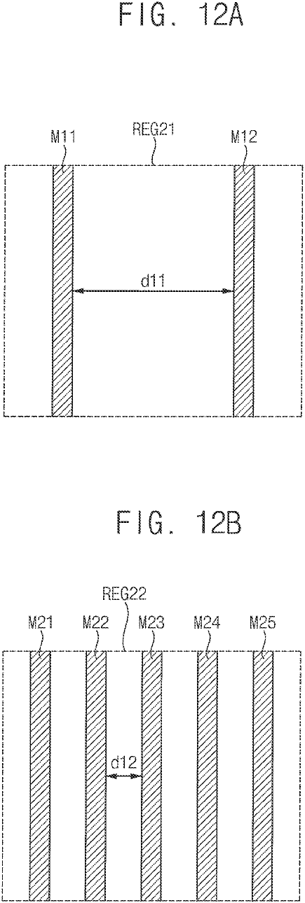

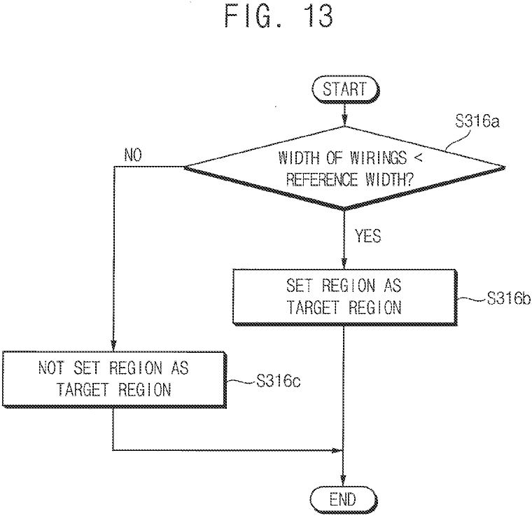

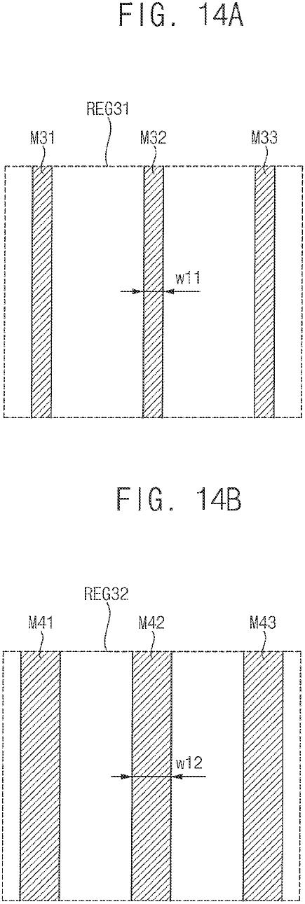

FIG. 13 is a flowchart further illustrating in still another example the setting of the target region on a partial region of a semiconductor device in FIG. 8, and FIGS. 14A and 14B are respective, conceptual diagrams further illustrating the method of FIG. 13.

Referring to FIGS. 8, 13, 14A and 14B, when setting the target region on the partial region of the semiconductor device (S310), a width of wirings arranged in a specific region included in the semiconductor device may be compared with a reference width (S316a). If the width of the wirings arranged in the specific region is less than the reference width (S316a=YES), the specific region may be set as the target region (S316b). However, if the width of the wirings arranged in the specific region is greater than or equal to the reference width (step S316a=NO), the specific region may not be set as the target region (S316c). That is, the determination of whether a specific region may be designated as a white space region may be made on the basis of whether a width of the wirings arranged in the specific region.

As described before in relation to FIG. 11, the wirings arranged in the specific region may include clock wirings, non-clock signal wirings, power wirings and/or ground wirings.

Referring to FIG. 14A, a region REG31 in the semiconductor device may include wirings M31, M32 and M33, wherein a width w11 of the wiring M32 is less than the reference width. Thus, the region REG31 may be designated (or set) as the target region. However, in contrast and referring to FIG. 14B, a region REG32 in the semiconductor device may include wirings M41, M42 and M43, wherein a width of wiring M42 is greater than or equal to the reference width. Hence, although the region REG32 of FIG. 14B and the region REG31 of FIG. 14A include the same number of wirings, the region REG32 may be deemed as including white space than the region REG31, therefore the region REG32 may not be designated as a target region.

Although certain embodiments of the inventive concept have been described in relation to FIGS. 9, 10, 11, 12A, 12B, 13, 14A and 14B, those skilled in the art will appreciate that a target region may be set in accordance with a design method according to embodiments of the inventive concept according to one or more predetermined conditions or criteria (e.g., location of a specific region, wiring density in the specific region, width of wirings arranged in the specific region, etc.).

FIG. 15 is a flowchart further illustrating in another example (S330) the setting of the target region on the first layout (S300) in FIG. 1.

Referring to FIGS. 1 and 15, when setting the target region on the first layout (S300), the target region may be set on a partial sub-region of at least one block (e.g., a first block) among the plurality of blocks included in the semiconductor device (S330). In this regard, a white space region may be set as the target region.

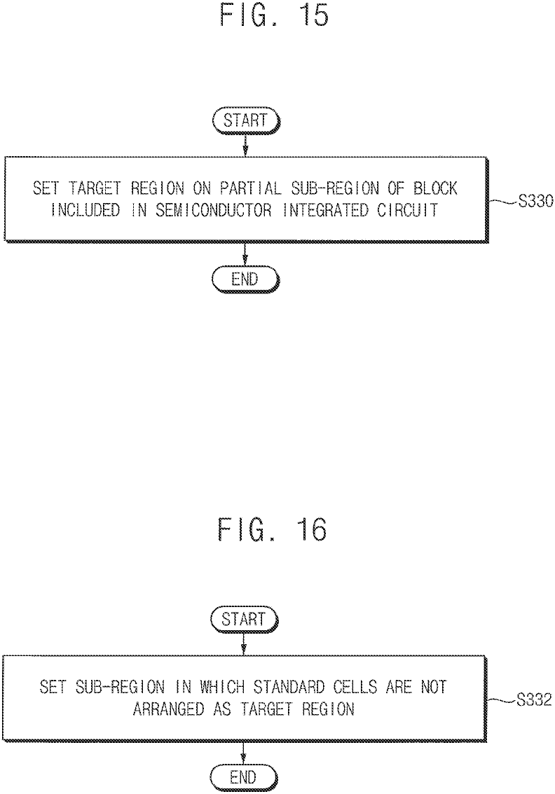

FIG. 16 is a flowchart further illustrating in one example (S332) the setting the target region on the partial sub-region of at least one block (S330) in FIG. 15, and FIG. 17 is a conceptual diagram further illustrating the method of FIG. 16.

Referring to FIGS. 15, 16 and 17, when setting of the target region on the partial sub-region of the at least one block among the plurality of blocks included in the semiconductor device (S330), a specific sub-region in a specific block included in the semiconductor device in which the plurality of standard cells are not arranged may be designated (or set) as the target region (S332).

For example, as illustrated in FIG. 17, a plurality of standard cells SC11, SC12, SC13, SC14, SC15, SC16, SC17 and SC18 (hereafter, “standard cells SC11 to SC18”) may be disposed in a block 400 included in the semiconductor device. A first target region, sub-region SREG11, proximate to an upper right corner and a right edge of the block 400 may include a standard decoupling capacitor cell SDCC21 and a filler cell FC21, since the standard cells SC11 to SC18 are not arranged therein. Alternately or additionally, a second target region, sub-region SREG12 proximate to a center portion of the block 400 may include a standard decoupling capacitor cell SDCC22, since the standard cells SC11 to SC18 are not arranged therein.

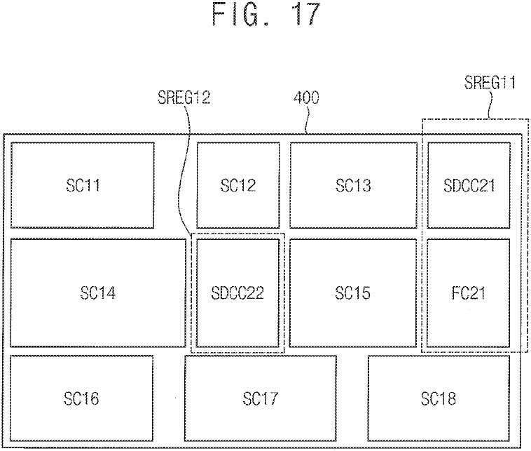

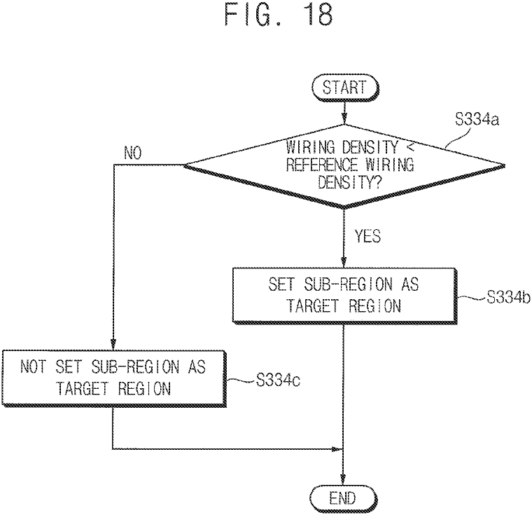

FIGS. 18 and 19 are respective flowcharts further illustrating examples of setting a target region on a partial sub-region of at least one block in FIG. 15.

Referring to FIGS. 15 and 18, when setting the target region on the partial sub-region of the at least one block among the plurality of blocks included in the semiconductor device (S330), a wiring density of a specific sub-region in a specific block included in the semiconductor device may be compared with a reference wiring density (S334a). If the wiring density of the specific sub-region is less than the reference wiring density (S334a=YES), the specific sub-region may be set as the target region (S334b). However, if the wiring density of the specific sub-region is greater than or equal to the reference wiring density (S334a=NO), the specific sub-region may not be set as the target region (S334c).

Referring to FIGS. 15 and 19, when setting the target region on the partial sub-region of the at least one block among the plurality of blocks included in the semiconductor device (S330), a width of wirings arranged in a specific sub-region in a specific block included in the semiconductor device may be compared with a reference width (S336a). If the width of the wirings arranged in the specific sub-region is less than the reference width (S336a=YES), the specific sub-region may be set as the target region (S336b). However, if the width of the wirings arranged in the specific sub-region is greater than or equal to the reference width (step S336a=NO), the specific sub-region may not be set as the target region (S336c).

In some embodiments, the designation of a specific region as a target region may be made in relation to two or more conditions, such as the conditions described in relation to FIGS. 9, 11, 13, 16, 18 and 19.

FIG. 20 is a flowchart further illustrating an example (S410) of the obtaining of the second layout (S400) in FIG. 1.

Referring to FIGS. 1 and 20, when obtaining the second layout of the semiconductor device (S400), the first decoupling capacitor cell having a first structure may be replaced with a second decoupling capacitor cell having a second structure different from the first structure of the first decoupling capacitor cell (S410).

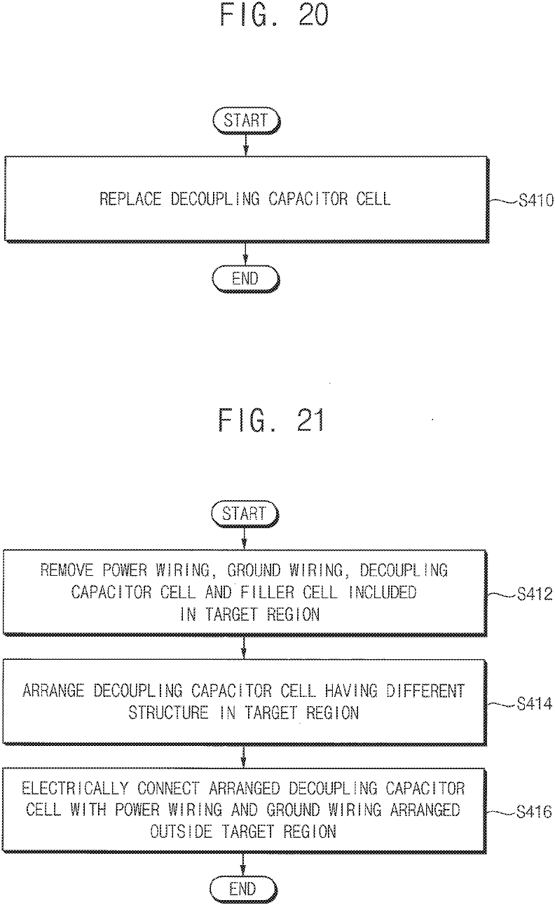

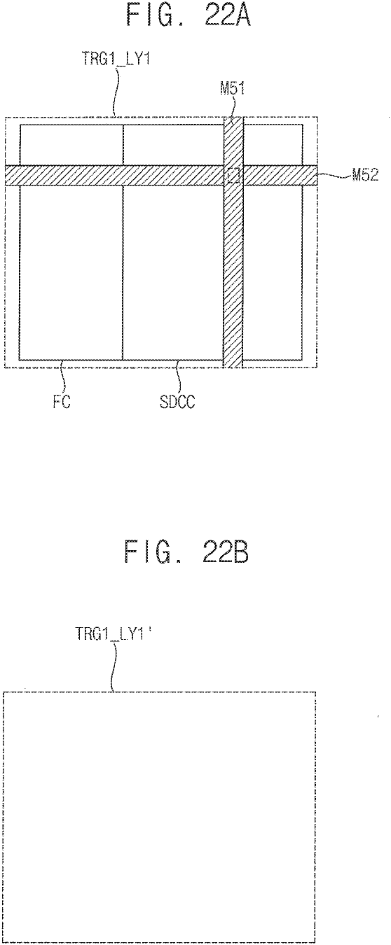

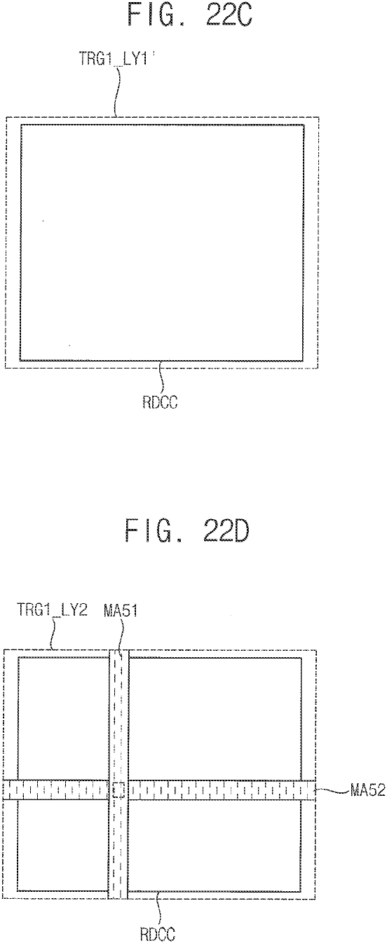

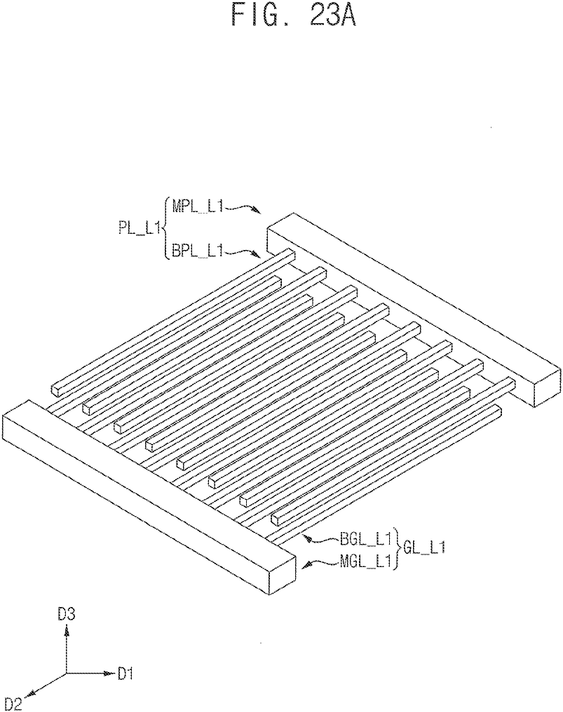

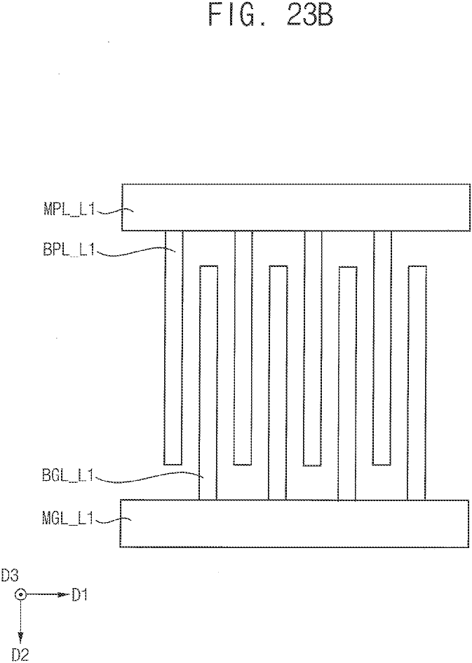

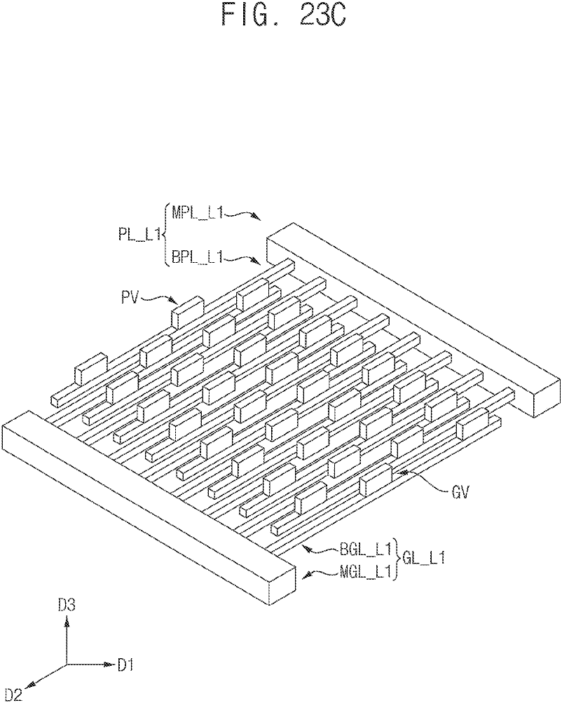

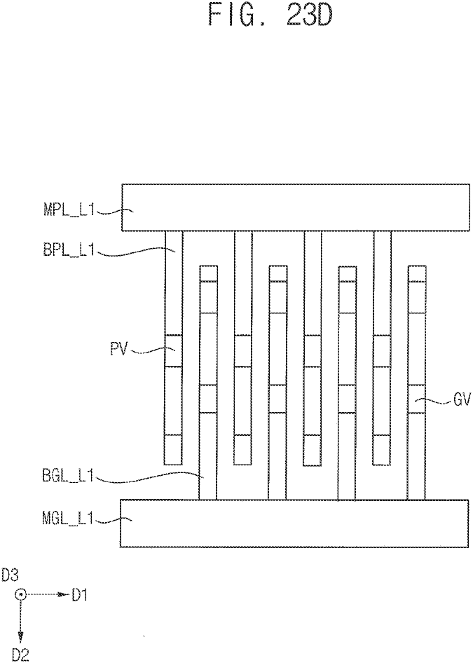

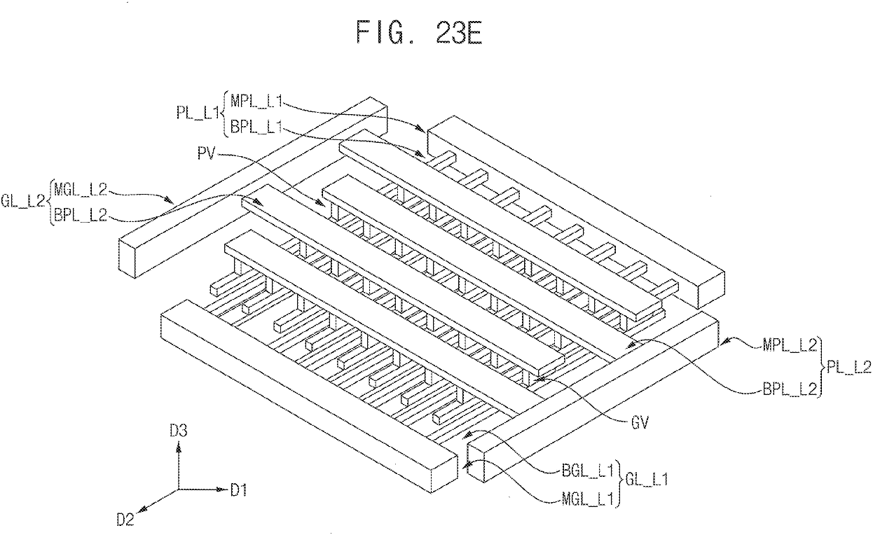

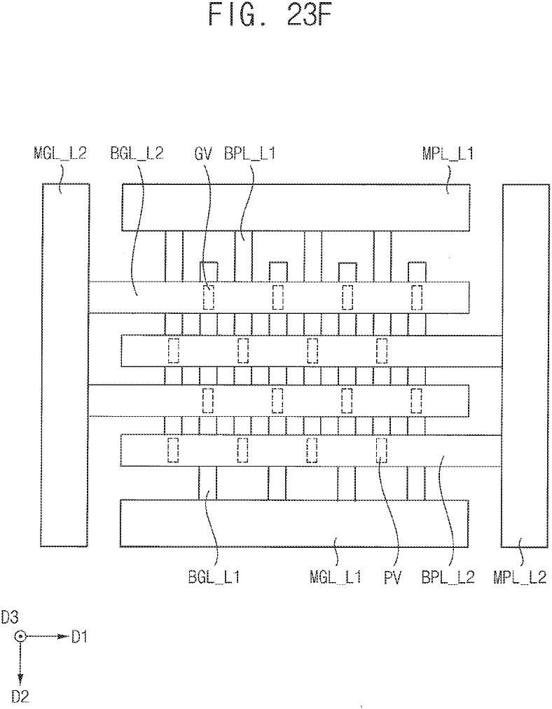

FIG. 21 is a flowchart further illustrating in one example the replacing of the first decoupling capacitor cell with a second decoupling capacitor cell (S410) in FIG. 20. Here, FIGS. 22A, 22B, 22C, 22D, 23A, 23B, 23C, 23D, 23E and 23F are respective diagrams further illustrating the method of FIG. 21.

Referring to FIGS. 20, 21, 22A, 22B, 22C and 22D, when replacing the first decoupling capacitor cell with the second decoupling capacitor cell (S410), a first power wiring, a first ground wiring, the first decoupling capacitor cell and a first filler cell included in the target region may be variously removed, deleted or erased (S412). The second decoupling capacitor cell may be arranged in the target region (S414). The second decoupling capacitor cell may be electrically connected with a second power wiring and a second ground wiring that are arranged outside the target region (S416).

For example, as illustrated in FIG. 22A, before method step S410 is performed, a target region TRG1_LY1 included in the first layout may include power/ground wirings M51 and M52, a first decoupling capacitor cell SDCC and a filler cell FC.

As illustrated in FIG. 22B, when method step S412 is performed, the power/ground wirings M51 and M52, the first decoupling capacitor cell SDCC and the filler cell FC in a target region TRG1_LY1′ may be removed. Here, if clock/non-clock signal wirings and/or a standard cell exist in the target region, the clock/non-clock signal wirings or the standard cell may be maintained without removal.

As illustrated in FIG. 22C, when method step S414 is performed, a second decoupling capacitor cell RDCC may be arranged in the target region TRG1_LY1′. The second decoupling capacitor cell RDCC may have a structure different from that of the first decoupling capacitor cell SDCC, and may have a larger decoupling capacitance and less leakage power than the first decoupling capacitor cell SDCC. For example, the second decoupling capacitor cell RDCC may be a routing cell-type decoupling capacitor cell (or a routing decoupling capacitor cell).

As illustrated in FIG. 22D, when method step S416 is performed, additional power/ground wirings MA51 and MA52 may be arranged and may be connected to power/ground wirings outside a target region TRG1_LY2 included in the second layout such that power/ground voltages are supplied to the second decoupling capacitor cell RDCC in the target region TRG1_LY2.

Referring to 23A, 23B, 23C, 23D, 23E and 23F, another possible example of the second decoupling capacitor cell RDCC is illustrated. For example, the second decoupling capacitor cell RDCC may have a vertical natural capacitor (VNCAP) structure.

As illustrated in FIGS. 23A and 23B, first power lines PL_L1 and first ground lines GL_L1 may be formed in a first wiring layer. The first power lines PL_L1 may include a first main power line MPL_L1 extending in the first direction D1, and first branch power lines BPL_L1 extending in the second direction D2 from the first main power line MPL_L1 and formed in plural along the first direction D1. Similarly, the first ground lines GL_L1 may include a first main ground line MGL_L1 and first branch ground lines BGL_L1. The first branch power lines BPL_L1 and the first branch ground lines BGL_L1 may be alternately arranged along the first direction D1.

As illustrated in FIGS. 23C and 23D, first power vias PV extending in the third direction D3 may be formed on the first branch power lines BPL_L1, and first ground vias GV extending in the third direction D3 may be formed on the first branch ground lines BGL_L1.

As illustrated in FIGS. 23E and 23F, second power lines PL_L2 and second ground lines GL_L2 may be formed in a second wiring layer adjacent to the first wiring layer (e.g., on the first wiring layer). The second power lines PL_L2 may include a second main power line MPL_L2 extending in the second direction D2, and second branch power lines BPL_L2 extending in the first direction D1 from the second main power line MPL_L2 and formed in plural along the second direction D2. Similarly, the second ground lines GL_L2 may include a second main ground line MGL_L2 and second branch ground lines BGL_L2. The second branch power lines BPL_L2 and the second branch ground lines BGL_L2 may be alternately disposed along the second direction D2. The first and second branch power lines BPL_L1 and BPL_L2 may be electrically connected by the first power vias PV, and the first and second branch ground lines BGL_L1 and BGL_L2 may be electrically connected by the first ground vias GV.

Therefore, the second decoupling capacitor cell (e.g., routing decoupling capacitor cell) of a two-stacked structure having a relatively large decoupling capacitance and low leakage power may be formed or implemented. However, the scope of the inventive concept is not limited thereto, and the second decoupling capacitor cell may have a three (or more) stacked structure or may have various other structures.

FIG. 24 is a flowchart further illustrating in another example (S430) the obtaining of the second layout (S400) in FIG. 1.

Referring to FIGS. 1 and 24, when obtaining the second layout of the semiconductor device (S400), a first modified decoupling capacitor cell may be generated or formed by adding at least one additional wiring to the first decoupling capacitor cell while maintaining a structure of the first decoupling capacitor cell (S430). That is, the first decoupling capacitor cell may be modified to generate the first modified decoupling capacitor cell.

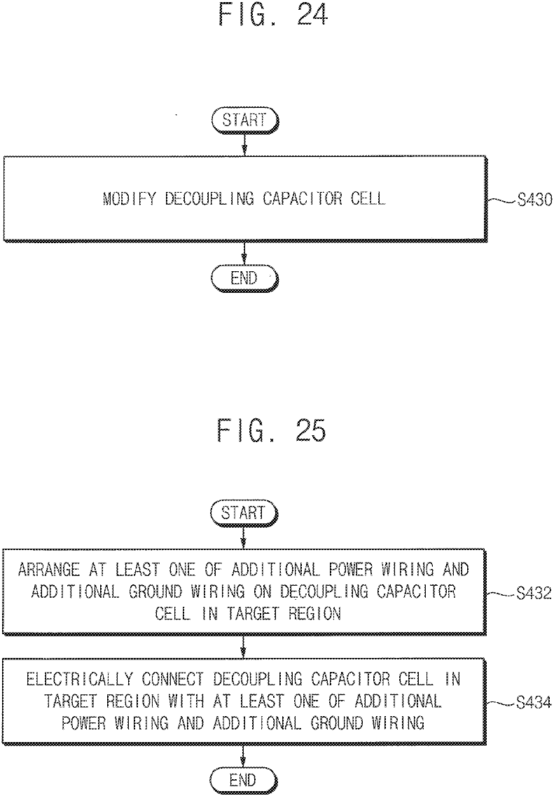

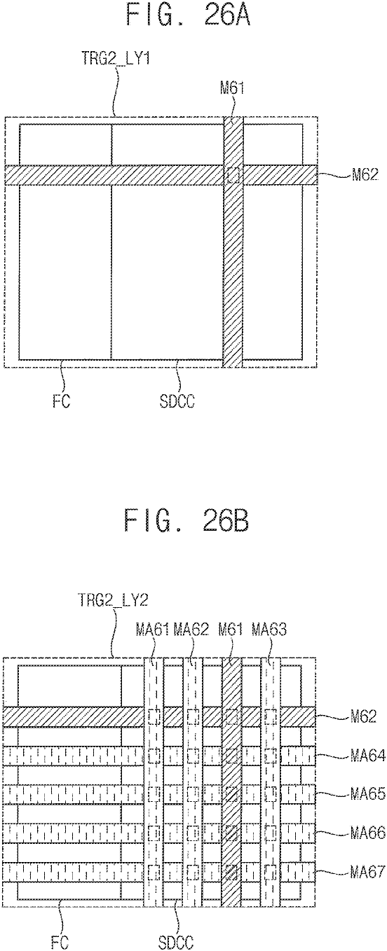

FIG. 25 is a flowchart further illustrating in one example the modifying of the decoupling capacitor cell in FIG. 24, and FIGS. 26A and 26B are respective, conceptual diagrams further illustrating the method of FIG. 25.

Referring to FIGS. 24, 25, 26A and 26B, when generating the first modified decoupling capacitor cell (S430), at least one of an additional power wiring and an additional ground wiring may be arranged on the first decoupling capacitor cell in the target region (S432). The first decoupling capacitor cell may be electrically connected with at least one of the additional power wiring and the additional ground wiring (S434).

For example, as illustrated in FIG. 26A, before method step S430 is performed, a target region TRG2_LY1 included in the first layout may include power/ground wirings M61 and M62, a first decoupling capacitor cell SDCC and a filler cell FC.

As illustrated in FIG. 26B, when method steps S432 and S434 are performed, additional power/ground wirings MA61, MA62, MA63, MA64, MA65, MA66 and MA67 may be arranged on and connected to the first decoupling capacitor cell SDCC in a target region TRG2_LY2 included in the second layout.

FIG. 27 is a flowchart illustrating a method of designing a semiconductor device according to embodiments of the inventive concept.

Referring to FIG. 27, in a method of designing a semiconductor device according to embodiments of the inventive concept, a behavior level design (or behavior level design process) – corresponding to a functional design of the semiconductor device – may be performed (S1100).

The behavior level design may be referred to as an architecture design or a high level design (or high level design process). The high level design may represent that a semiconductor device to be designed or as a target device is depicted at an algorithm level and is described in terms of high-level computer language (e.g., C language).

Next, an RTL design (or RTL design process) of the semiconductor device may be performed (S1200), and a verification may be performed on the semiconductor device on which the RTL design has been completed (S1300).

Devices and/or circuits designed by the high level design process may be more concretely described by an RTL coding or simulation in step S1200 and S1300. In addition, codes generated by the RTL coding may be converted into a netlist, and the results may be combined with each other to realize the entire semiconductor device. The combined schematic circuit may be verified by a simulation tool. In some embodiments, an adjusting operation may be further performed in consideration of a result of the verification.

The RTL may be used for representing a coding style used in hardware description languages for effectively ensuring that code models may be synthesized in a certain hardware platform such as an FPGA or an ASIC (e.g., code models may be converted into real logic functions). One or more hardware description language(s) may be used for generating RTL modules, such as System Verilog, Verilog, VHDL, etc.

Thereafter, a gate level design (or gate level design process) of the semiconductor device may be performed (S1400), and a verification may be performed on the semiconductor device on which the gate level design has been completed (S1500).

The gate level design may represent that a semiconductor device is depicted using basic logic gates, such as AND gates and OR gates, and is described by logical connections and timing information of the logic gates. For example, all signals may be discrete signals and may only have a logical value of zero, one, X and Z (or high-Z).

Thereafter, a layout level design (or layout level design process) of the semiconductor device may be performed (S1600), and a verification may be performed on the semiconductor device on which the layout level design has been completed (S1700).

The layout level design may be referred to as a physical design (or physical design process). The layout level design may be performed to implement or realize a logically completed semiconductor device on a silicon substrate. For example, the layout level design may be performed based on the schematic circuit prepared in the high level design or the netlist corresponding thereto. The layout level design may include a routing operation of placing and connecting various standard cells that are provided from a cell library, based on a predetermined design rule. For example, the standard cell library SCL and the design rule DR in FIGS. 4 and 5 may be used for the layout level design.

A cell library for the layout level design may contain information on operation, speed, and power consumption of the standard cells. In some embodiments, the cell library for representing a layout of a circuit having a specific gate level may be defined in a layout design tool. Here, the layout may be prepared to define or describe shapes and sizes of patterns constituting transistors and metal interconnection lines, which will be actually formed on a silicon substrate. For example, layout patterns (e.g., PMOS, NMOS, N-WELL, gate electrodes, and metal interconnection lines thereon) may be suitably disposed to actually form an inverter circuit on a silicon substrate. For this, at least one of inverters defined in the cell library may be selected.

Herein, the term “standard cell” is used to denote a unit of an integrated circuit in which a size of the layout meets a preset rule or criterion. The standard cell may include an input pin and an output pin and may process a signal received through the input pin to output a signal through the output pin. For example, the standard cell may include a basic cell such as an AND logic gate, an OR logic gate, a NOR logic gate, or an inverter, a complex cell such as an OR/AND/INVERTER (OAI) or an AND/OR/INVERTER (AOI), and a storage element such as a master-slave flip flop or a latch.

In addition, the routing operation may be performed on selected and disposed standard cells. That is, the routing operation may be performed on the selected and disposed standard cells to connect them to upper interconnection lines. By the routing operation, the standard cells may be electrically connected to meet a design.

Layout design schemes may be classified into a full custom type for manually performing a work according to a work type using a layout editor, an auto placement and routing (P&R) type using an auto P&R tool, and a semi-custom type using all of the above-described types.

During method step S1700, a verification operation may be performed on the layout to check whether there is a portion violating the given design rule, after the routing operation. In some embodiments, the verification operation may include evaluating verification items, such as a design rule check (DRC), an electrical rule check (ERC), and a layout vs schematic (LVS). The evaluating of the DRC item may be performed to evaluate whether the layout meets the given design rule. The evaluating of the ERC item may be performed to evaluate whether there is an issue of electrical disconnection in the layout. The evaluating of the LVS item may be performed to evaluate whether the layout is prepared to coincide with the gate level netlist.

When method steps S1600 and S1700 are performed, a method of designing the layout of the semiconductor device according to embodiments of the inventive concept may be applied. (See, e.g., the various example embodiment described in relation to FIGS. 1 through 26 above).

FIG. 28 is a flowchart illustrating a method of manufacturing a semiconductor device according to embodiments of the inventive concept.

Referring to FIG. 28, in a method of manufacturing a semiconductor device according to embodiments of the inventive concept, the semiconductor device may be designed (S2100), and then the semiconductor device may be fabricated in accordance with (e.g., based on) result of the designing of the semiconductor device (S2200). For example, method step S2100 may be performed in accordance with the method of designing the semiconductor device described in relation to FIG. 27.

During the method step S2200, the semiconductor device may be fabricated (or manufactured) using a sequence of conventionally understood manufacturing techniques (e.g., masking, material deposition, etching, cleaning, testing, assembly, packaging, etc.). Thus, a corrected layout may be generated by performing optical proximity correction on the design layout, and a photo mask may be fabricated or manufactured based on the corrected layout. Various types of exposure and etching processes may be repeatedly performed using the photo mask, and patterns corresponding to the layout design may be sequentially formed on a substrate through these processes. Thereafter, the semiconductor device may be obtained in the form of a semiconductor chip through various additional processes.

As will be appreciated by those skilled in the art, the inventive concept may be embodied as a system, method, computer program product, and/or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain or store a program for use by or in connection with an instruction execution system, apparatus, or device. For example, the computer readable medium may be a non-transitory computer readable medium.

The inventive concept may be applied to various electronic devices and systems that include the semiconductor devices and the semiconductor devices. For example, the inventive concept may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, etc.

The foregoing is illustrative of example embodiments and is not to be construed as limiting thereof. Although some example embodiments have been described, those skilled in the art will readily appreciate that many modifications are possible in the example embodiments without materially departing from the novel teachings and advantages of the inventive concept. Accordingly, all such modifications are intended to be included within the scope of the example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of designing a layout of a semiconductor device, the method comprising:
receiving input data defining the semiconductor device;
obtaining a first layout of the semiconductor device by performing a placement and routing in response to the input data, wherein the first layout includes a plurality of blocks, a plurality of standard cells, a plurality of decoupling capacitor cells, a plurality of filler cells, a plurality of power wirings, a plurality of ground wirings, a plurality of clock wirings, and a plurality of non-clock signal wirings;
setting a target region on the first layout, wherein the target region includes a first decoupling capacitor cell among the plurality of decoupling capacitor cells; and
obtaining a second layout of the semiconductor device by changing the first decoupling capacitor cell in the target region.

2. The method of claim 1, wherein the obtaining of the second layout includes:
replacing the first decoupling capacitor cell having a first structure with a second decoupling capacitor cell having a second structure different from the first structure.

3. The method of claim 2, wherein the target region further includes a first filler cell, and
the replacing of the first decoupling capacitor cell with the second decoupling capacitor cell includes:
removing at least one of a first power wiring and a first ground wiring from at least one of the first decoupling capacitor cell and the first filler cell;
arranging the second decoupling capacitor cell in the target region; and
electrically connecting the second decoupling capacitor cell with at least one of a second power wiring and a second ground wiring disposed external to the target region.

4. The method of claim 2, wherein the second decoupling capacitor cell includes:
a first power wiring and a first ground wiring in a first wiring layer among a plurality of vertically stacked wiring layers, wherein the first power wiring and first ground wiring extend in a first direction;
a second power wiring and a second ground wiring in a second wiring layer adjacent to the first wiring layer, wherein the second power line and second ground line extend in a second direction intersecting the first direction;
a first via electrically connecting the first power wiring and the second power wiring; and
a second via electrically connecting the first ground wiring and the second ground wiring.

5. The method of claim 1, wherein the obtaining of the second layout includes:
generating a first modified decoupling capacitor cell by adding at least one additional wiring to the first decoupling capacitor cell while otherwise maintaining a structure of the first decoupling capacitor cell.

6. The method of claim 5, wherein the generating of the first modified decoupling capacitor cell includes:
arranging at least one of an additional power wiring and an additional ground wiring in relation to the first decoupling capacitor cell in the target region; and
electrically connecting the first decoupling capacitor cell to the at least one of the additional power wiring and the additional ground wiring.

7. The method of claim 1, wherein the setting of the target region on the first layout includes:
setting the target region on a partial region of the semiconductor device.

8. The method of claim 7, wherein the setting of the target region on the partial region of the semiconductor device includes:
setting a first region included in the semiconductor device as the target region, wherein the plurality of blocks and the plurality of standard cells are not disposed in the first region.

9. The method of claim 8, wherein the first region is proximate to at least one of a corner of the semiconductor device, an edge portion of the semiconductor device, and a center portion of the semiconductor device.

10. The method of claim 7, wherein the setting of the target region on the partial region of the semiconductor device includes:
upon determining that a wiring density of a first region included in the semiconductor device is less than a reference wiring density, setting the first region as the target region.

11. The method of claim 10, wherein the first region includes at least one of a clock wiring among the plurality of clock wirings and a non-clock signal wiring among the plurality of non-clock signal wirings, and
the wiring density of the first region is determined in accordance with the at least one of the clock wiring and a non-clock signal wiring.

12. The method of claim 7, wherein the setting of the target region on the partial region of the semiconductor device includes:
upon determining that a width of wirings disposed in a first region included in the semiconductor device is less than a reference width, setting the first region as the target region.

13. The method of claim 1, wherein the setting of the target region on the first layout includes:
setting the target region on a partial sub-region of a first block among the plurality of blocks included in the semiconductor device.

14. The method of claim 13, wherein the setting of the target region on the partial sub-region of the first block includes at least one of:
upon determining that the plurality of standard cells is not disposed in first sub-region, setting a first sub-region included in the first block as the target region;
upon determining that a wiring density of a first sub-region included in the first block is less than a reference wiring density, setting the first sub-region as the target region; and
upon determining that a width of wirings disposed in a first sub-region included in the first block is less than a reference width, setting the first sub-region as the target region.

15. The method of claim 1, wherein the obtaining of the first layout includes:
developing a floor plan for the plurality of blocks, the plurality of standard cells, the plurality of decoupling capacitor cells and the plurality of filler cells;
developing a power plan for the plurality of power wirings and the plurality of ground wirings;
performing a placement of elements included in the plurality of blocks and the plurality of standard cells;
performing a clock tree synthesis (CTS) of clock signals provided to the elements via the plurality of clock wirings; and
performing a routing of non-clock signals provided to the elements via the plurality of non-clock signal wirings.

16. The method of claim 15, further comprising:
verifying results of the placement and routing, wherein the setting of the target region on the first layout and the obtaining of the second layout are performed during the verifying results of the placement and routing.

17. The method of claim 16, wherein the verifying results of the placement and routing includes:
performing a timing engineering change order (ECO) process; and thereafter,
determining whether a timing condition has been satisfied.

18. The method of claim 17, wherein upon determining the timing condition has been satisfied, the method further comprises:
performing a physical design rule check and correction.

19. A design system for a semiconductor device, the design system comprising:
a storage device configured to store information including procedures; and
a processor configured to access the storage device and execute the procedures, and
wherein the procedures includes a design module configured to:
receive input data defining the semiconductor device;
obtain a first layout of the semiconductor device by performing a placement and routing in response to the input data, the first layout including a plurality of blocks, a plurality of standard cells, a plurality of decoupling capacitor cells, a plurality of filler cells, a plurality of power wirings, a plurality of ground wirings, a plurality of clock wirings, and a plurality of non-clock signal wirings;
set a target region on the first layout, wherein the target region includes a first decoupling capacitor cell among the plurality of decoupling capacitor cells; and
obtain a second layout of the semiconductor device by changing the first decoupling capacitor cell in the target region.

20. A method of designing a layout of a semiconductor device, the method comprising:
receiving input data defining the semiconductor device;
obtaining a first layout of the semiconductor device by performing a placement and routing in response to the input data, wherein the obtaining of the first layout of the semiconductor device includes:
developing a floor plan for a plurality of blocks, a plurality of standard cells, a plurality of decoupling capacitor cells and a plurality of filler cells included in the semiconductor device;
developing a power plan for a plurality of power wirings and a plurality of ground wirings included in the semiconductor device;
performing a placement of elements included in the plurality of blocks and the plurality of standard cells;
performing a clock tree synthesis (CTS) for clock signals provided to the elements via a plurality of clock wirings included in the semiconductor device; and
performing a routing of non-clock signals provided to the elements via a plurality of non-clock signal wirings included in the semiconductor device;
verifying results of the placement and routing;
while verifying results of the placement and routing, setting a target region on the first layout, wherein the target region includes a first decoupling capacitor cell among the plurality of decoupling capacitor cells and the plurality of standard cells is not disposed in the target region; and
while verifying results of the placement and routing, obtaining a second layout of the semiconductor device by replacing the first decoupling capacitor cell in the target region with a second decoupling capacitor cell having a structure different from that of the first decoupling capacitor cell,
wherein the target region is a sub-region of the semiconductor device proximate to at least one of a corner of the semiconductor device and an edge portion of the semiconductor device, and
the replacing of the first decoupling capacitor cell with the second decoupling capacitor cell includes:
removing at least one of a first power wiring and a first ground wiring from the first decoupling capacitor cell;
arranging the second decoupling capacitor cell in the target region, and
electrically connecting the second decoupling capacitor cell to a second power wiring and a second ground wiring external to the target region.
